(19) United States
(12) Patent Application Publication
(10) Pub. No.: US 2020/0090548 A1
(43) Pub. Date: Mar. 19, 2020

(54) IMAGE PROCESSING APPARATUS, IMAGE PROCESSING METHOD, AND COMPUTER-READABLE RECORDING MEDIUM

(71) Applicant: OLYMPUS CORPORATION, Tokyo (JP)

(72) Inventors: Mitsutaka KIMURA, Tokyo (JP); Takashi KONO, Tokyo (JP); Yamato KANDA, Tokyo (JP)

(73) Assignee: OLYMPUS CORPORATION, Tokyo (JP)

(21) Appl. No.: 16/686,284

(22) Filed: Nov. 18, 2019

Related U.S. Application Data
(63) Continuation of application No. PCT/JP2017/018743, filed on May 18, 2017.

(51) Int. Cl. G09B 23/28; G06T 7/00

(52) U.S. Cl. CPC G09B 23/285; G06T 2207/30096; G06T 2207/10068; G06T 7/0016

(57) ABSTRACT

An image processing apparatus includes a processor including hardware. The processor is configured to evaluate, based on information including an image which is captured by an endoscope and is sequentially input, a technical level of an operator who operates the endoscope, and measure a transit time of a specific section.

### CROSS-REFERENCE TO RELATED APPLICATION

This application is a continuation of International Application No. PCT/JP2017/018743, filed on May 18, 2017, the entire contents of which are incorporated herein by reference.

### BACKGROUND

### 1. Technical Field

The present disclosure relates to an image processing apparatus, an image processing method, and a computer-readable recording medium for evaluating a technical level of an operator based on information including an image from an endoscope.

### 2. Related Art

Japanese Patent No. 4708963 discloses a technology of detecting and displaying a curved shape at an insertion portion of an endoscope. In this technology, the curved shape at the insertion portion of the endoscope is displayed, and thus a practitioner of the endoscope is caused to recognize the current shape of the insertion portion of the endoscope.

### SUMMARY

In some embodiments, an image processing apparatus includes a processor including hardware. The processor is configured to evaluate, based on information including an image which is captured by an endoscope and is sequentially input, a technical level of an operator who operates the endoscope, and measure a transit time of a specific section.

In some embodiments, an image processing method includes: acquiring information including an image which is captured by an endoscope and is sequentially input; evaluating a technical level of an operator who operates the endoscope based on the information; and measuring a transit time of a specific section.

In some embodiments, provided is a non-transitory computer-readable recording medium with an executable program stored thereon. The program causes an image processing apparatus to execute: acquiring information including an image which is captured by an endoscope and is sequentially input; evaluating a technical level of an operator who operates the endoscope based on the information; and measuring a transit time of a specific section.

The above and other features, advantages and technical and industrial significance of this disclosure will be better understood by reading the following detailed description of presently preferred embodiments of the disclosure, when considered in connection with the accompanying drawings.

### BRIEF DESCRIPTION OF THE DRAWINGS

FIG. 1 is a block diagram illustrating a configuration of an image processing apparatus according to a first embodiment of the disclosure;

FIG. 2 is a flowchart illustrating an outline of processing performed by the image processing apparatus according to the first embodiment of the disclosure;

FIG. 3 is a flowchart illustrating an outline of operation-level evaluation-value calculation processing in FIG. 2;

FIG. 4 is a flowchart illustrating an outline of specific scene determination processing in FIG. 3;

FIG. 5 is a block diagram illustrating a configuration of an image processing apparatus according to a first modification example of the first embodiment of the disclosure;

FIG. 6 is a flowchart illustrating an outline of specific scene determination processing performed by the image processing apparatus according to the first modification example of the first embodiment of the disclosure;

FIG. 7 is a block diagram illustrating a configuration of an image processing apparatus according to a second modification example of the first embodiment of the disclosure;

FIG. 8 is a flowchart illustrating an outline of the specific scene determination processing performed by the image processing apparatus according to the second modification example of the first embodiment of the disclosure;

FIG. 9 is a block diagram illustrating a configuration of an image processing apparatus according to a third modification example of the first embodiment of the disclosure;

FIG. 10 is a flowchart illustrating an outline of the specific scene determination processing performed by the image processing apparatus according to the third modification example of the first embodiment of the disclosure;

FIG. 11 is a block diagram illustrating a configuration of an image processing apparatus according to a fourth modification example of the first embodiment of the disclosure;

FIG. 12 is a flowchart illustrating an outline of the specific scene determination processing performed by the image processing apparatus according to the fourth modification example of the first embodiment of the disclosure;

FIG. 13 is a block diagram illustrating a configuration of an image processing apparatus according to a fifth modification example of the first embodiment of the disclosure;

FIG. 14 is a flowchart illustrating an outline of the specific scene determination processing performed by the image processing apparatus according to the fifth modification example of the first embodiment of the disclosure;

FIG. 15 is a block diagram illustrating a configuration of an image processing apparatus according to a second embodiment of the disclosure;

FIG. 16 is a flowchart illustrating an outline of operation-level evaluation-value calculation processing performed by the image processing apparatus according to the second embodiment of the disclosure;

FIG. 17 is a flowchart illustrating an outline of time measurement processing in FIG. 16;

FIG. 18 is a flowchart illustrating an outline of specific section determination processing in FIG. 17;

FIG. 19 is a flowchart illustrating an outline of time calculation processing in FIG. 17;

FIG. 20 is a block diagram illustrating a configuration of an image processing apparatus according to a first modification example of the second embodiment of the disclosure;

FIG. 21 is a flowchart illustrating an outline of the specific section determination processing performed by the image processing apparatus according to the first modification example of the second embodiment of the disclosure;

FIG. 22 is a flowchart illustrating an outline of the time calculation processing performed by the image processing apparatus according to the first modification example of the second embodiment of the disclosure;

FIG. 23 is a block diagram illustrating a configuration of an image processing apparatus according to a third embodiment of the disclosure;

FIG. 24 is a flowchart illustrating an outline of the time measurement processing performed by the image processing apparatus according to the third embodiment of the disclosure;

FIG. 25 is a flowchart illustrating an outline of removal determination processing in FIG. 24;

FIG. 26 is a block diagram illustrating a configuration of an image processing apparatus according to a first modification example of the third embodiment of the disclosure;

FIG. 27 is a flowchart illustrating an outline of the removal determination processing performed by the image processing apparatus according to the first modification example of the third embodiment of the disclosure;

FIG. 28 is a block diagram illustrating a configuration of an image processing apparatus according to a second modification example of the third embodiment of the disclosure;

FIG. 29 is a flowchart illustrating an outline of the removal determination processing performed by the image processing apparatus according to the second modification example of the third embodiment of the disclosure;

FIG. 30 is a block diagram illustrating a configuration of an image processing apparatus according to a fourth embodiment of the disclosure;

FIG. 31 is a flowchart illustrating an outline of the time measurement processing performed by the image processing apparatus according to the fourth embodiment of the disclosure;

FIG. 32 is a flowchart illustrating an outline of interested-region handling time exclusion processing in FIG. 31;

FIG. 33 is a block diagram illustrating a configuration of an image processing apparatus according to a first modification example of the fourth embodiment of the disclosure;

FIG. 34 is a flowchart illustrating an outline of the interested-region handling time exclusion processing performed by the image processing apparatus according to the first modification example of the fourth embodiment of the disclosure;

FIG. 35 is a flowchart illustrating an outline of differentiation time measurement processing in FIG. 34;

FIG. 36 is a block diagram illustrating a configuration of an image processing apparatus according to a second modification example of the fourth embodiment of the disclosure;

FIG. 37 is a flowchart illustrating an outline of the differentiation time measurement processing performed by the image processing apparatus according to the second modification example of the fourth embodiment of the disclosure;

FIG. 38 is a block diagram illustrating a configuration of an image processing apparatus according to a third modification example of the fourth embodiment of the disclosure;

FIG. 39 is a flowchart illustrating an outline of the differentiation time measurement processing performed by the image processing apparatus according to the third modification example of the fourth embodiment of the disclosure;

FIG. 40 is a block diagram illustrating a configuration of an image processing apparatus according to a fourth modification example of the fourth embodiment of the disclosure;

FIG. 41 is a flowchart illustrating an outline of the interested-region handling time exclusion processing performed by the image processing apparatus according to the fourth modification example of the fourth embodiment of the disclosure; and

FIG. 42 is a flowchart illustrating an outline of treatment time measurement processing in FIG. 41.

### DETAILED DESCRIPTION

Hereinafter, an image processing apparatus, an image processing method, and a program according to embodiments of the disclosure will be described with reference to the drawings. The disclosure is not limited by the embodiments. In the drawings, the same components are denoted by the same reference signs.

### First Embodiment

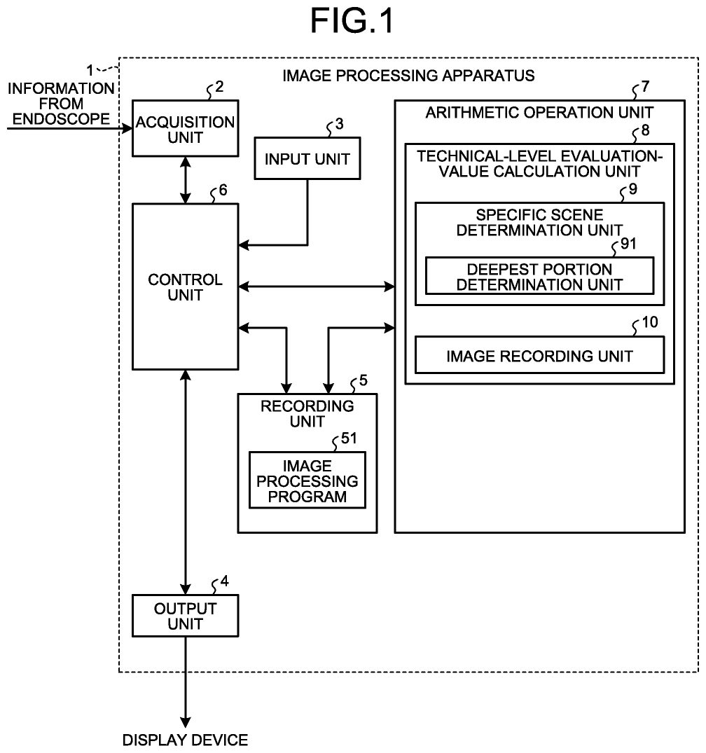

Configuration of Image Processing Apparatus FIG. 1 is a block diagram illustrating a configuration of an image processing apparatus according to a first embodiment of the disclosure. According to the first embodiment, an image processing apparatus 1 is an apparatus that calculates an evaluation value indicating a technical level of an operator of an endoscope based on intraluminal images arranged in chronological order, in which the lumen of the subject is continuously imaged by an endoscope including a flexible endoscope, a rigid endoscope, and the like or a capsule endoscope (these are collectively and simply referred as “a medical apparatus” below) or on images arranged in chronological order in which the subject is continuously imaged by an industrial endoscope, as an example. Generally, the image is a color image having pixel levels (pixel values) for wavelength components of red (R), green (G), and blue (B) at each pixel position. The lesion region is a specific region in which a lesion or a portion appearing abnormality, such as bleeding, redness, coagulated blood, tumor, erosion, ulcer, aphtha, and villi abnormality, is photographed. That is, the lesion region is an abnormal region. Information from the endoscope include operation information of an operator (practitioner) for the endoscope, type information regarding the type of illumination light for irradiation of the endoscope, information from sensors such as an acceleration sensor, a temperature sensor, and a magnetic generation sensor, which are provided at a distal end of the endoscope, and shape information regarding the shape of the distal end of the endoscope, in addition to the images.

As illustrated in FIG. 1, the image processing apparatus 1 includes an acquisition unit 2 that acquires information from an endoscope, which includes images captured by the endoscope, an input unit 3 that receives an input signal input by an operation from the outside, an output unit 4 that outputs an image or various kinds of information to a display device, a recording unit 5 that records the image acquired by the acquisition unit 2 and various programs, a control unit 6 that controls an overall operation of the image processing apparatus 1, and an arithmetic operation unit 7 that performs predetermined arithmetic processing. In the first embodiment, the acquisition unit 2 acquires an image from an external endoscope. However, for example, an imaging unit having an imaging function may be provided in the image processing apparatus 1 and may capture an image of a subject as an endoscope.

The acquisition unit 2 is appropriately configured in accordance with a form of a system including the medical apparatus. For example, in a case where a portable recording medium is used for transmitting and receiving an intraluminal image to and from the medical apparatus, the acquisition unit 2 is configured as a reader device in which the recording medium is mounted to be detachable, and the recorded intraluminal image is read. In a case using a server that records an image captured by the endoscope, the acquisition unit 2 is configured by a communication device and the like capable of bidirectionally communicating with the server, and thus acquires the image by performing data communication with the server. Further, the acquisition unit 2 may be configured by an interface device and the like to which an image is input from the endoscope through a cable.

The input unit 3 is realized, for example, by an input device such as a keyboard, a mouse, a touch panel, and various switches. The input unit 3 outputs the input signal received by an operation from the outside, to the control unit 6. The input unit 3 is not necessarily wired, and may be wireless, for example.

The output unit 4 outputs information or an image extracted by an arithmetic operation of the arithmetic operation unit 7 to a display device connected by a wired connection or to a display device and the like connected by a wireless communication, based on control of the control unit 6. The output unit 4 may be configured using a display panel such as liquid crystal or organic electroluminescence (EL) and the like. Thus, the output unit 4 may display various images including an image subjected to image processing by an arithmetic operation of the arithmetic operation unit 7 or may output sound, characters, and the like.

The recording unit 5 is realized by various IC memories such as a flash memory, a read only memory (ROM), and a random access memory (RAM), and a hard disk which is mounted therein or is connected by a data communication terminal, and the like. The recording unit 5 records a program for operating the image processing apparatus 1 and causing the image processing apparatus 1 to perform various functions or a program for operating the image processing apparatus 1, data used in execution of the program, and the like, in addition to an image or a video acquired by the acquisition unit 2. For example, the recording unit 5 records an image processing program 51 for performing an optical flow and the like on an intraluminal image and various kinds of information used in execution of this program, and the like. When the arithmetic operation unit 7 performs lesion detection and the like, the recording unit 5 records a template in which features of a lesion and the like are set in advance, or a criterion used for determining the lesion.

The control unit 6 is configured using a general-purpose processor such as a central processing unit (CPU) or using a dedicated processor such as various arithmetic operation circuits such as an application specific integrated circuit (ASIC) and a field programmable gate array (FPGA), that perform specific functions. In a case where the control unit 6 is a general-purpose processor, the control unit 6 totally controls an operation of the entirety of the image processing apparatus 1 in a manner that the control unit 6 performs an instruction, data transmission, or the like to each unit constituting the image processing apparatus 1 by reading various programs stored by the recording unit 5. In a case where the control unit 6 is a dedicated processor, the processor may independently perform various kinds of processing. The processor may use various kinds of data and the like stored by the recording unit 5, and thereby the processor and the recording unit 5 may cooperate or combine to perform various kinds of processing.

The arithmetic operation unit 7 is configured using a general-purpose processor such as a CPU or a dedicated processor such as various arithmetic operation circuits such as an ASIC and an FPGA, that perform specific functions. In a case where the arithmetic operation unit 7 is a general-purpose processor, the arithmetic operation unit reads the image processing program 51 from the recording unit 5, and thereby performs processing of calculating an operation level evaluation value based on the acquired image. The operation level evaluation value indicates a technical level of an operator of the endoscope. In a case where the arithmetic operation unit 7 is a dedicated processor, the processor may independently perform various kinds of processing. The processor and the recording unit 5 may cooperate or combine to execute various processes, by using various kinds of data and the like stored by the recording unit 5.

Detailed Configuration of Arithmetic Operation Unit Next, a detailed configuration of the arithmetic operation unit 7 will be described. The arithmetic operation unit 7 includes a technical-level evaluation-value calculation unit 8.

The technical-level evaluation-value calculation unit 8 calculates and outputs an evaluation value of a technical level of the operator of the endoscope based on an image group which has been acquired by the acquisition unit 2 through the control unit 6 or the recording unit 5 and is sequentially input from the endoscope. The technical-level evaluation-value calculation unit 8 includes a specific scene determination unit 9 and an image recording unit 10.

The specific scene determination unit 9 determines a specific scene photographed in an image acquired by the acquisition unit 2. The specific scene determination unit 9 includes a deepest portion determination unit 91 that determines to be a deepest portion as a target.

The image recording unit 10 adds predetermined information to an image of a specific scene determined by the specific scene determination unit 9. Here, the predetermined information refers to identification information for distinguishing the image of the specific scene from a general image, for example, to a flag. The image recording unit 10 separately preserves the image of the specific scene. The image recording unit 10 may add different identification information to each specific scene, for example, a large intestine scene and a stomach scene.

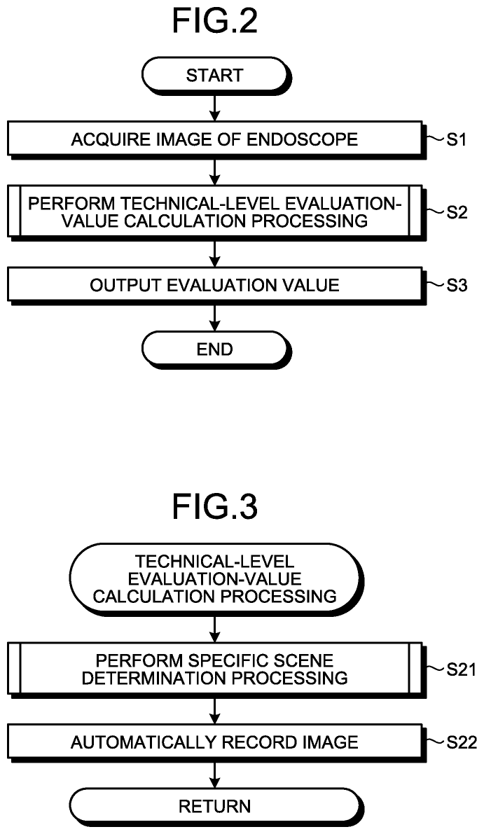

Processing of Image Processing Apparatus Next, processing performed by the image processing apparatus 1 will be described. FIG. 2 is a flowchart illustrating an outline of the processing performed by the image processing apparatus 1.

As illustrated in FIG. 2, firstly, the acquisition unit 2 acquires an image of an endoscope (Step S1).

The technical-level evaluation-value calculation unit 8 performs operation-level evaluation-value calculation processing of calculating an evaluation value (indicating the technical level of an operator of the endoscope) based on an image group of the endoscope, which has been sequentially acquired by the acquisition unit 2 (Step S2). After Step S2, the image processing apparatus 1 causes the process to proceed to Step S3 described later.

Operation-Level Evaluation-Value Calculation Processing

FIG. 3 is a flowchart illustrating an outline of operation-level evaluation-value calculation processing in Step S2 in FIG. 2.

As illustrated in FIG. 3, the specific scene determination unit 9 performs specific scene determination processing of determining whether or not the image acquired by the acquisition unit 2 indicates a specific scene (Step S21). After Step S21, the image processing apparatus 1 causes the process to proceed to Step S22 described later.

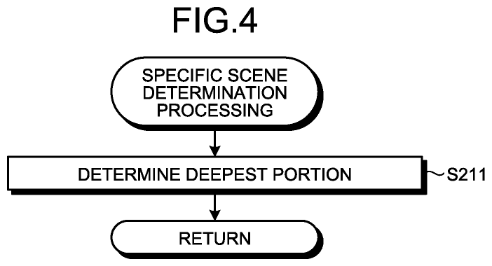

Specific Scene Determination Processing FIG. 4 is a flowchart illustrating an outline of the specific scene determination processing in Step S21 in FIG. 3.

As illustrated in FIG. 4, the deepest portion determination unit 91 determines whether or not a deepest portion set as a target by the endoscope is provided in the image acquired by the acquisition unit 2 (Step S211). Here, the deepest portion is in the lumen and refers to any of the duodenum, the pylorus, the cardia, the ileocecum, the Bauhin valve, the vermiform appendix, and the rectum. The deepest portion as the target may be set in advance by the input unit 3. The deepest portion may be automatically set by extracting feature data from the image with the well-known technology and estimating the position of the distal end portion of the endoscope in the lumen based on the extracted feature data. The deepest portion determination unit 91 may compare the image acquired by the acquisition unit 2 to an identifier created by machine learning and determine whether or not there is the deepest portion. After Step S211, the image processing apparatus 1 returns to a subroutine of the above-described operation-level evaluation-value calculation processing in FIG. 3.

Returning to FIG. 3, descriptions of the processing subsequent to Step S22 continue.

In Step S22, the image recording unit 10 adds predetermined information to the image of the specific scene determined by the specific scene determination unit 9. Specifically, the image recording unit 10 distinguishes (identifies) the image of the specific scene determined by the specific scene determination unit 9 (for example, image determined that the portion is the deepest portion, by the deepest portion determination unit 91) from other images (normal images) and adds identification information (flag) indicating an image to be recorded in the recording unit 5. The image recording unit 10 may add information (flag) indicating that the image of the specific scene determined by the specific scene determination unit 9 is to be recorded as an image separate from the image group acquired by the acquisition unit 2. The image recording unit 10 may add information (flag) indicating that the image of the specific scene determined by the specific scene determination unit 9 is to be recorded as an image different from the normal image. The image recording unit 10 associates an evaluation value and the information (flag) with the image of the specific scene determined by the specific scene determination unit 9 and records a result of the association in the recording unit 5. The evaluation value indicates that the endoscope reaches the deepest portion (for example, “1” in a case of reaching the deepest portion, and “0” in a case of not reaching the deepest portion). The information (flag) indicates that the image of the specific scene is to be recorded as an image separate from the image group acquired by the acquisition unit 2. After Step S22, the image processing apparatus 1 returns to the above-described main routine in FIG. 2.

Returning to FIG. 2, descriptions of the processing subsequent to Step S3 continue.

In Step S3, the output unit 4 outputs the evaluation value calculated by the technical-level evaluation-value calculation unit 8 to the display device. The output unit 4 may record the evaluation value in the recording unit 5 in addition to outputting of the evaluation value to the display device. The output unit 4 may output the evaluation value to a report using an endoscope, such as an examination record. The output unit 4 may output the evaluation value itself to the outside. The output unit 4 may use the evaluation value for threshold determination and the like used in another examination and the like, and thus may convert the evaluation value into a new evaluation value (word corresponding to the evaluation value) and output the converted value. The output unit 4 is not limited to being connected to the image processing apparatus 1. The output unit 4 may be a terminal wirelessly connected, or may be an information device, a server, or a database on a network. After Step S3, the image processing apparatus 1 ends this processing.

According to the first embodiment of the disclosure described above, the image determined to be the specific scene from the image group captured by the endoscope is distinguished from another image and is recorded in the recording unit 5. Thus, it is possible to collect information regarding the technical level of the operator who operates the endoscope.

According to the first embodiment of the disclosure, it is possible to collect information indicating whether or not the endoscope can reach the deepest portion as the specific scene by the operation of the operator. Thus, it is possible to recognize the technical level evaluation value of the operator.

### First Modification Example of First Embodiment

Next, a first modification example of the first embodiment in the disclosure will be described. In the first modification example in the first embodiment, an image processing apparatus has a configuration different from that of the above-described image processing apparatus 1 according to the first embodiment, and the specific scene determination processing performed by the image processing apparatus is different. In the following descriptions, the configuration of the image processing apparatus according to the first modification example of the first embodiment will be described. Then, specific scene determination processing performed by the image processing apparatus according to the first modification example of the first embodiment will be described. The same components as those of the above-described image processing apparatus 1 according to the first embodiment are denoted by the same reference signs, and descriptions thereof will be omitted.

Configuration of Image Processing Apparatus

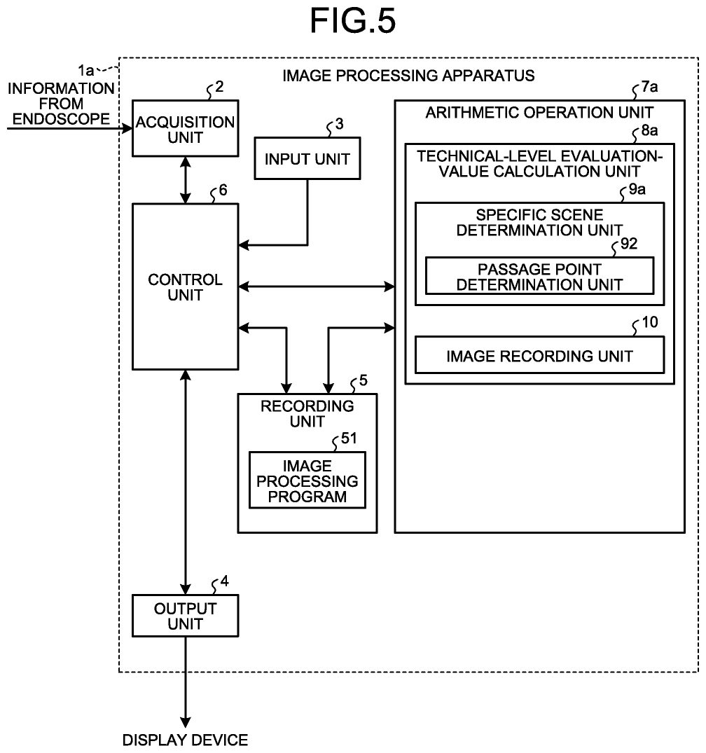

FIG. 5 is a block diagram illustrating the configuration of the image processing apparatus according to the first modification example of the first embodiment of the disclosure. An image processing apparatus 1a illustrated in FIG. 5 includes an arithmetic operation unit 7a instead of the arithmetic operation unit 7 according to the first embodiment described above. The arithmetic operation unit 7a includes a technical-level evaluation-value calculation unit 8a instead of the technical-level evaluation-value calculation unit 8 according to the first embodiment described above. The technical-level evaluation-value calculation unit 8a includes a specific scene determination unit 9a instead of the specific scene determination unit 9 according to the first embodiment described above. The specific scene determination unit 9a includes a passage point determination unit 92 instead of the deepest portion determination unit 91 according to the first embodiment described above.

The passage point determination unit 92 determines whether or not an image acquired by the acquisition unit 2 shows a preset passage point.

Specific Scene Determination Processing

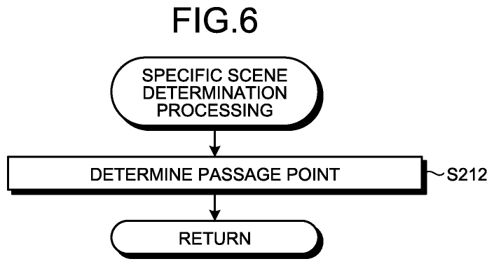

Next, specific scene determination processing performed by the image processing apparatus 1a will be described. FIG. 6 is a flowchart illustrating an outline of the specific scene determination processing performed by the image processing apparatus 1a.

As illustrated in FIG. 6, the passage point determination unit 92 determines whether or not an image acquired by the acquisition unit 2 shows a preset passage point (Step S212). Specifically, the passage point determination unit 92 determines whether or not the image acquired by the acquisition unit 2 shows any of the mouth, the nasopharynx, the cardia, the pylorus, the vestibule, the farther papilla, the jejunum, the ileum, the vermiform appendix, the ileocecum, the Bauhin valve, the ascending colon, the transverse colon, the descending colon, the sigmoid colon, the rectum, and the anus. For example, the passage point determination unit 92 extracts feature data from the image acquired by the acquisition unit 2. The passage point determination unit 92 determines whether or not the features correspond to any of the mouth, the nasopharynx, the cardia, the pylorus, the vestibule, the farther papilla, the jejunum, the ileum, the vermiform appendix, the ileocecum, the Bauhin valve, the ascending colon, the transverse colon, the descending colon, the sigmoid colon, the rectum, and the anus. After Step S212, the image processing apparatus 1a returns to the above-described subroutine in FIG. 3.

According to the first modification example of the first embodiment of the disclosure, it is possible to exhibit an effect similar to that in the first embodiment described above and to collect information indicating whether or not the endoscope can reach the passage point as the specific scene by the operation of the operator. Thus, it is possible to recognize the technical level evaluation value of the operator.

### Second Modification Example of First Embodiment

Next, a second modification example of the first embodiment in the disclosure will be described. In the second modification example in the first embodiment, an image processing apparatus has a configuration different from that of the above-described image processing apparatus 1 according to the first embodiment, and the specific scene determination processing performed by the image processing apparatus is different. In the following descriptions, the configuration of the image processing apparatus according to the second modification example of the first embodiment will be described. Then, specific scene determination processing performed by the image processing apparatus according to the second modification example of the first embodiment will be described. The same components as those of the above-described image processing apparatus 1 according to the first embodiment are denoted by the same reference signs, and descriptions thereof will be omitted.

Configuration of Image Processing Apparatus

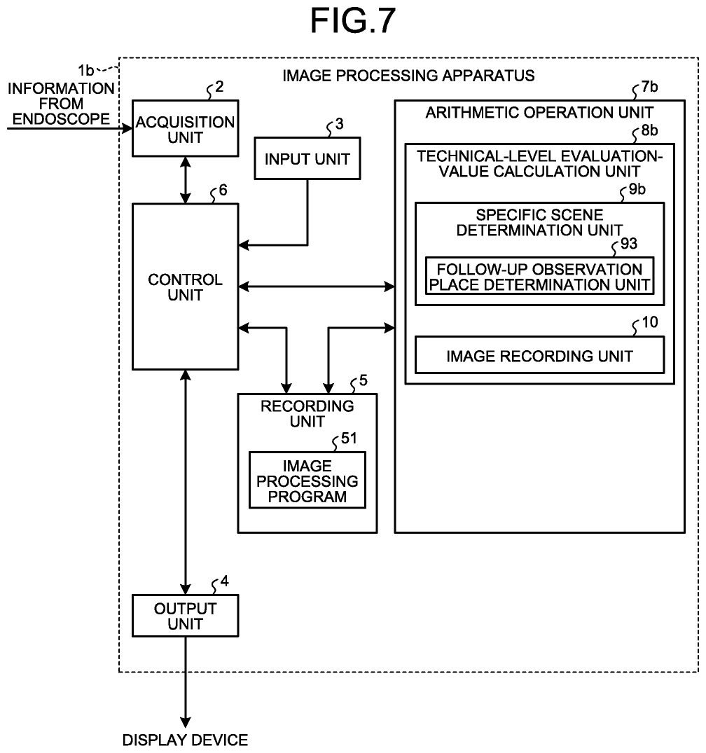

FIG. 7 is a block diagram illustrating the configuration of the image processing apparatus according to the second modification example of the first embodiment of the disclosure. An image processing apparatus 1b illustrated in FIG. 7 includes an arithmetic operation unit 7b instead of the arithmetic operation unit 7 according to the first embodiment described above. The arithmetic operation unit 7b includes a technical-level evaluation-value calculation unit 8b instead of the technical-level evaluation-value calculation unit 8 according to the first embodiment described above. The technical-level evaluation-value calculation unit 8b includes a specific scene determination unit 9b instead of the specific scene determination unit 9 according to the first embodiment described above. The specific scene determination unit 9b includes a follow-up observation place determination unit 93 instead of the deepest portion determination unit 91 according to the first embodiment described above.

The follow-up observation place determination unit 93 determines whether or not an image acquired by the acquisition unit 2 shows a target place of follow-up observation.

Specific Scene Determination Processing

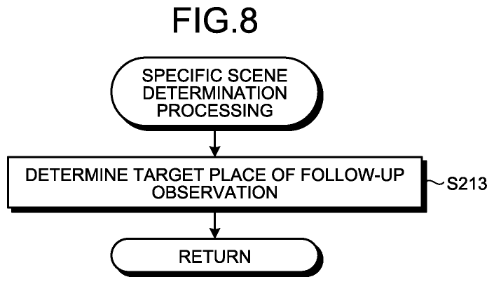

Next, specific scene determination processing performed by the image processing apparatus 1b will be described. FIG. 8 is a flowchart illustrating an outline of the specific scene determination processing performed by the image processing apparatus 1b.

As illustrated in FIG. 8, the follow-up observation place determination unit 93 determines whether or not an image acquired by the acquisition unit 2 shows a target place of follow-up observation (Step S213). Specifically, the follow-up observation place determination unit 93 determines whether or not the image acquired by the acquisition unit 2 shows an abnormal place which has been previously recognized using an endoscope, a capsule endoscope, an ultrasound endoscope, CT, MRI, and the like. Here, in a case of a biological lumen, the abnormal place is a lesion place (abnormal region) as a target of follow-up observation and is a not-treated lesion place. In a case of an industrial endoscope, the abnormal place refers to a small crack, a tear, or the like which has been found in the previous examination and is a place at which the crack, the tear, or the like is not repaired. The follow-up observation place determination unit 93 may determine whether or not the image shows the target place of the follow-up observation, based on position information acquired in the previous examination and a position of the distal end of the endoscope. Regarding the determination of the position, the position may be detected based on the image, or may be detected based on information from a sensor provided at the distal end portion of the endoscope. After Step S213, the image processing apparatus 1b returns to the above-described subroutine in FIG. 3.

According to the second modification example of the first embodiment of the disclosure, it is possible to exhibit an effect similar to that in the first embodiment described above and to collect information indicating whether or not the endoscope can reach the target place of follow-up observation, which is the specific scene by the operation of the operator. Thus, it is possible to recognize the technical level evaluation value of the operator.

### Third Modification Example of First Embodiment

Next, a third modification example of the first embodiment in the disclosure will be described. In the third modification example in the first embodiment, an image processing apparatus has a configuration different from that of the above-described image processing apparatus 1 according to the first embodiment, and the specific scene determination processing performed by the image processing apparatus is different. In the following descriptions, the configuration of the image processing apparatus according to the third modification example of the first embodiment will be described. Then, specific scene determination processing performed by the image processing apparatus according to the third modification example of the first embodiment will be described. The same components as those of the above-described image processing apparatus 1 according to the first embodiment are denoted by the same reference signs, and descriptions thereof will be omitted.

Configuration of Image Processing Apparatus

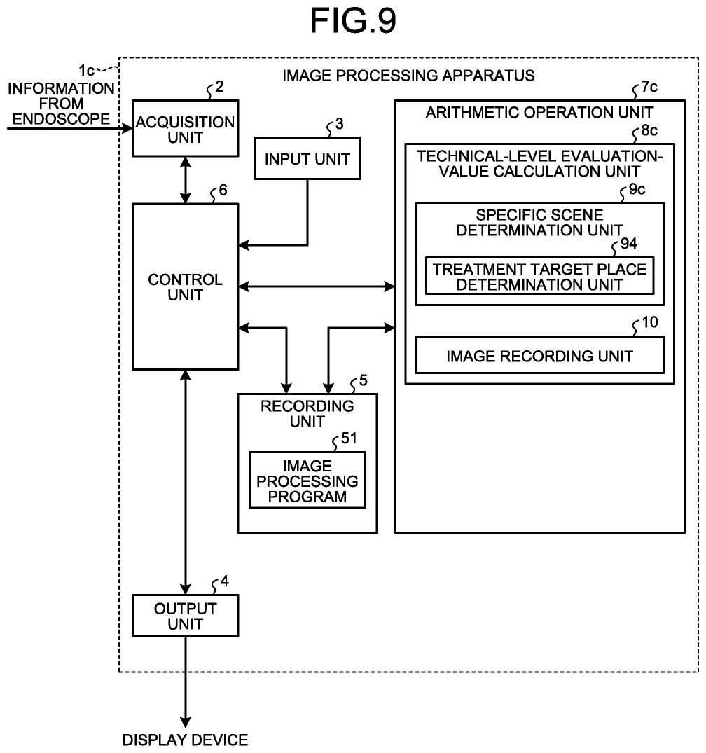

FIG. 9 is a block diagram illustrating the configuration of the image processing apparatus according to the third modification example of the first embodiment of the disclosure. An image processing apparatus 1c illustrated in FIG. 9 includes an arithmetic operation unit 7c instead of the arithmetic operation unit 7 according to the first embodiment described above. The arithmetic operation unit 7c includes a technical-level evaluation-value calculation unit 8c instead of the technical-level evaluation-value calculation unit 8 according to the first embodiment described above. The technical-level evaluation-value calculation unit 8c includes a specific scene determination unit 9c instead of the specific scene determination unit 9 according to the first embodiment described above. The specific scene determination unit 9c includes a treatment target place determination unit 94 instead of the deepest portion determination unit 91 according to the first embodiment described above.

The treatment target place determination unit 94 determines whether or not an image acquired by the acquisition unit 2 shows a target place for treatment.

Specific Scene Determination Processing

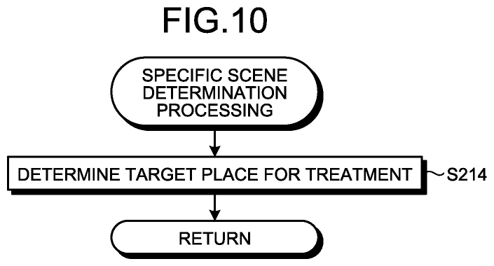

Next, specific scene determination processing performed by the image processing apparatus 1c will be described. FIG. 10 is a flowchart illustrating an outline of the specific scene determination processing performed by the image processing apparatus 1c.

As illustrated in FIG. 10, the treatment target place determination unit 94 determines whether or not an image acquired by the acquisition unit 2 shows a target place for treatment (Step S214). Specifically, the treatment target place determination unit 94 determines whether or not the image acquired by the acquisition unit 2 shows a treatment place (abnormal place) when the place has been previously recognized using an endoscope, a capsule endoscope, an ultrasound endoscope, CT, MRI, and the like. Here, in a case of the biological lumen, the treatment place means a treatment place being a lesion (abnormal region) as the target of follow-up observation and is a place at which the treatment place has been treated at least one time or more. In a case of the industrial endoscope, the treatment place means a crack, a damaged place, or the like which has been found in the previous examination and is a place at which the crack, a damaged place, or the like has been treated at least one time or more. The treatment target place determination unit 94 may determine whether or not the image shows the target place of the follow-up observation, based on position information acquired in the previous examination and a position of the distal end of the endoscope. Regarding the determination of the position, the position may be detected based on the image, or may be detected based on information from a sensor provided at the distal end portion of the endoscope. After Step S214, the image processing apparatus 1c returns to the above-described subroutine in FIG. 3.

According to the third modification example of the first embodiment of the disclosure, it is possible to exhibit an effect similar to that in the first embodiment described above and to collect information indicating whether or not the endoscope can reach the target place for treatment, which is the specific scene by the operation of the operator. Thus, it is possible to recognize the technical level evaluation value of the operator.

### Fourth Modification Example of First Embodiment

Next, a fourth modification example of the first embodiment in the disclosure will be described. In the fourth modification example in the first embodiment, an image processing apparatus has a configuration different from that of the above-described image processing apparatus 1 according to the first embodiment, and the specific scene determination processing performed by the image processing apparatus is different. In the following descriptions, the configuration of the image processing apparatus according to the fourth modification example of the first embodiment will be described. Then, specific scene determination processing performed by the image processing apparatus according to the fourth modification example of the first embodiment will be described. The same components as those of the above-described image processing apparatus 1 according to the first embodiment are denoted by the same reference signs, and descriptions thereof will be omitted.

Configuration of Image Processing Apparatus

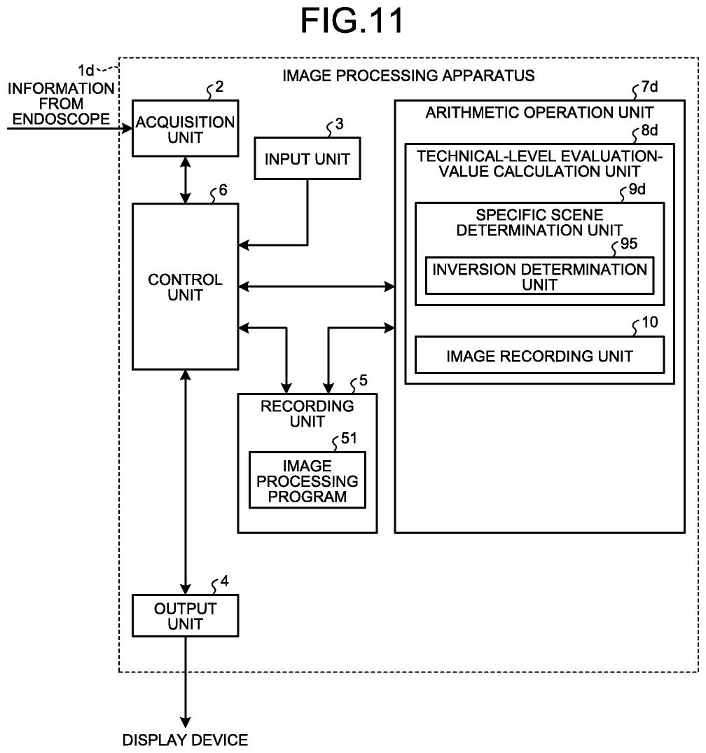

FIG. 11 is a block diagram illustrating the configuration of the image processing apparatus according to the fourth modification example of the first embodiment of the disclosure. An image processing apparatus 1d illustrated in FIG. 11 includes an arithmetic operation unit 7d instead of the arithmetic operation unit 7 according to the first embodiment described above. The arithmetic operation unit 7d includes a technical-level evaluation-value calculation unit 8d instead of the technical-level evaluation-value calculation unit 8 according to the first embodiment described above. The technical-level evaluation-value calculation unit 8d includes a specific scene determination unit 9d instead of the specific scene determination unit 9 according to the first embodiment described above. The specific scene determination unit 9d includes an inversion determination unit 95 instead of the deepest portion determination unit 91 according to the first embodiment described above.

The inversion determination unit 95 determines whether or not an endoscope is photographed in an image acquired by the acquisition unit 2.

Specific Scene Determination Processing

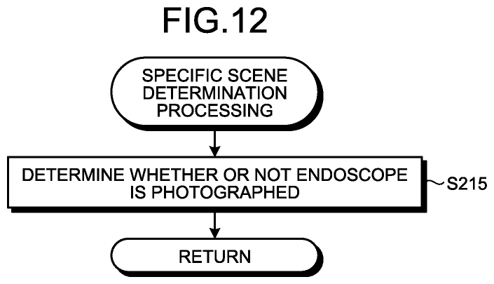

Next, specific scene determination processing performed by the image processing apparatus 1d will be described. FIG. 12 is a flowchart illustrating an outline of the specific scene determination processing performed by the image processing apparatus 1d.

As illustrated in FIG. 12, the inversion determination unit 95 determines whether or not an endoscope is photographed in an image acquired by the acquisition unit 2 (Step S215). For example, in a case where a practitioner inserts an endoscope into a large intestine of a subject, the practitioner checks the back of the large intestine or the rectum. Thus, the practitioner performs an observation while bending the distal end portion of the endoscope by operating an operating unit of the endoscope. Therefore, the inversion determination unit 95 determines whether or not the image acquired by the acquisition unit 2 is an image in which the endoscope is photographed (scene in which the endoscope is photographed). The inversion determination unit 95 may capture an image of the endoscope in advance, and may determine whether or not the endoscope is photographed in the image acquired by the acquisition unit 2, with the acquired image and well-known block matching. The inversion determination unit 95 may create an identifier (criterion) allowing determination of the endoscope in advance, and may determine whether or not the endoscope is photographed in the image acquired by the acquisition unit 2, by using the identifier (criterion). After Step S215, the image processing apparatus 1d returns to the above-described subroutine in FIG. 3.

According to the fourth modification example of the first embodiment of the disclosure, it is possible to exhibit an effect similar to that in the first embodiment described above and to collect information indicating whether or not the endoscope can reach the back of the large intestine or the rectum as the specific scene by the operation of the operator. Thus, it is possible to recognize the technical level evaluation value of the operator.

### Fifth Modification Example of First Embodiment

Next, a fifth modification example of the first embodiment in the disclosure will be described. In the fifth modification example in the first embodiment, an image processing apparatus has a configuration different from that of the above-described image processing apparatus 1 according to the first embodiment, and the specific scene determination processing performed by the image processing apparatus is different. In the following descriptions, the configuration of the image processing apparatus according to the fifth modification example of the first embodiment will be described. Then, specific scene determination processing performed by the image processing apparatus according to the fifth modification example of the first embodiment will be described. The same components as those of the above-described image processing apparatus 1 according to the first embodiment are denoted by the same reference signs, and descriptions thereof will be omitted.

Configuration of Image Processing Apparatus

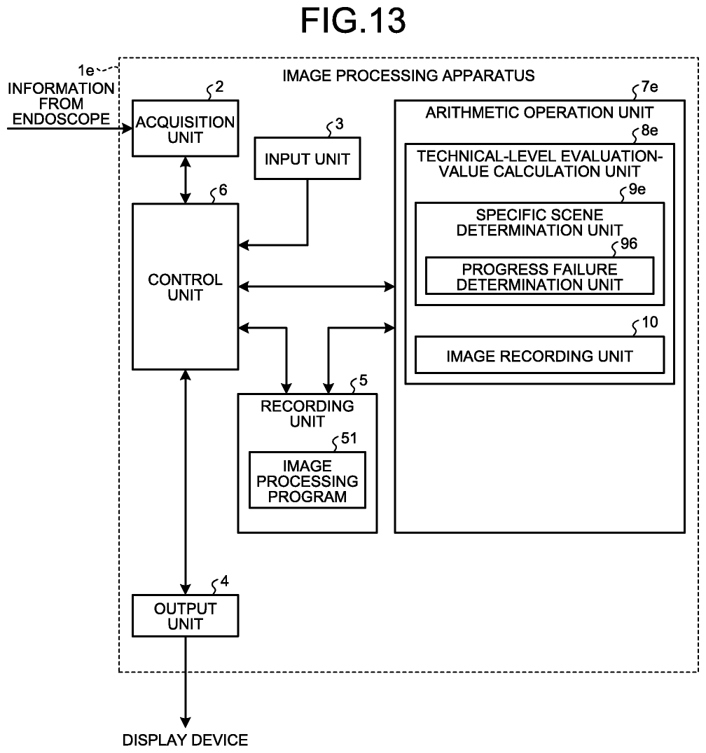

FIG. 13 is a block diagram illustrating the configuration of the image processing apparatus according to the fifth modification example of the first embodiment of the disclosure. An image processing apparatus 1e illustrated in FIG. 13 includes an arithmetic operation unit 7e instead of the arithmetic operation unit 7 according to the first embodiment described above. The arithmetic operation unit 7e includes a technical-level evaluation-value calculation unit 8e instead of the technical-level evaluation-value calculation unit 8 according to the first embodiment described above. The technical-level evaluation-value calculation unit 8e includes a specific scene determination unit 9e instead of the specific scene determination unit 9 according to the first embodiment described above. The specific scene determination unit 9e includes a progress failure determination unit 96 instead of the deepest portion determination unit 91 according to the first embodiment described above.

The progress failure determination unit 96 determines a target place at which the progress of the endoscope is not possible, based on an image acquired by the acquisition unit 2.

Specific Scene Determination Processing

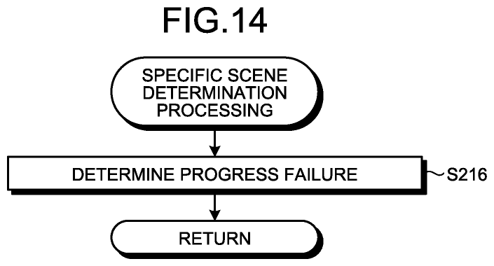

Next, specific scene determination processing performed by the image processing apparatus 1e will be described. FIG. 14 is a flowchart illustrating an outline of the specific scene determination processing performed by the image processing apparatus 1e.

As illustrated in FIG. 14, the progress failure determination unit 96 determines whether or not the image acquired by the acquisition unit 2 shows failure of the progress of the endoscope (Step S216). Specifically, in a case of the biological lumen, the progress failure determination unit 96 determines whether or not an occluded region in the lumen, which serves as a target place for the progress failure of the endoscope is included in the image acquired by the acquisition unit 2. The progress failure determination unit 96 compares the image acquired by the acquisition unit 2 to the preset criteria. The progress failure determination unit 96 determines whether or not an occluded place (for example, a progress-impossible place at which the inside of the lumen is occluded by intestinal obstruction, polyps, or the like, and thus the progress of the endoscope is not possible) in the lumen, which is a target place for the progress failure of the endoscope is included, based on a result of the comparison. The progress failure determination unit 96 may determine whether or not the occluded place in the lumen, which is the target place for the progress failure of the endoscope is included, based on a detection result (which is included in information acquired from the endoscope by the acquisition unit 2) of an acceleration sensor, which is obtained by detection of the sensor provided at the distal end portion of the endoscope. In a case where the endoscope is for industrial use, the progress failure determination unit 96 determines whether or not a damaged vascular line, an obstacle, or the like as the target place for the progress failure of the endoscope is included in the image acquired by the acquisition unit 2. After Step S216, the image processing apparatus 1d returns to the above-described subroutine in FIG. 3.

According to the fourth modification example of the first embodiment of the disclosure, it is possible to exhibit an effect similar to that in the first embodiment described above and to collect information indicating whether or not the endoscope can reach the target place for the progress failure, which is the specific scene by the operation of the operator. Thus, it is possible to recognize the technical level evaluation value of the operator.

### Second Embodiment

Next, a second embodiment in the disclosure will be described. In the second embodiment, an image processing apparatus has a configuration different from that of the above-described image processing apparatus according to the first embodiment, and operation-level evaluation-value calculation processing performed by the image processing apparatus is different. In the following descriptions, the configuration of the image processing apparatus according to the second embodiment will be described. Then, operation-level evaluation-value calculation processing performed by the image processing apparatus according to the second embodiment will be described. The same components as those of the above-described image processing apparatus 1 according to the first embodiment are denoted by the same reference signs, and descriptions thereof will be omitted.

Configuration of Image Processing Apparatus

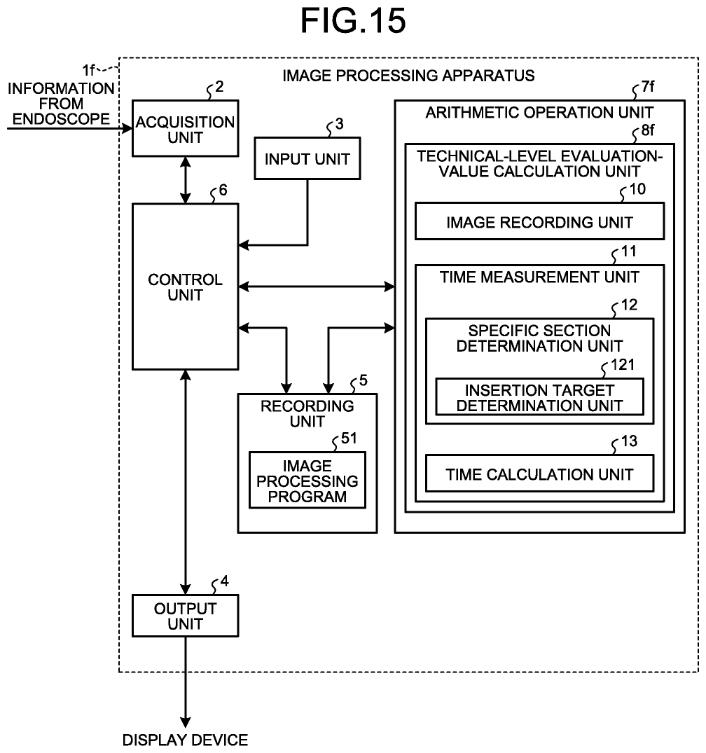

FIG. 15 is a block diagram illustrating a configuration of an image processing apparatus according to the second embodiment of the disclosure. An image processing apparatus 1f illustrated in FIG. 15 includes an arithmetic operation unit 7f instead of the arithmetic operation unit 7 according to the first embodiment described above. The arithmetic operation unit 7f includes a technical-level evaluation-value calculation unit 8f instead of the technical-level evaluation-value calculation unit 8 according to the first embodiment described above. The technical-level evaluation-value calculation unit 8f includes an image recording unit 10 and a time measurement unit 11.

The time measurement unit 11 measures a transit time of a specific section based on the image acquired by the acquisition unit 2. The time measurement unit 11 includes a specific section determination unit 12 that determines the specific section of an insertion target of the endoscope, and a time calculation unit 13 that calculates a difference between a start time and an end time of the specific section. The specific section determination unit 12 includes an insertion target determination unit 121 that determines a section in which the shape, the state, and the color of an insertion target are similar to those in the specific section.

Operation-Level Evaluation-Value Calculation Processing

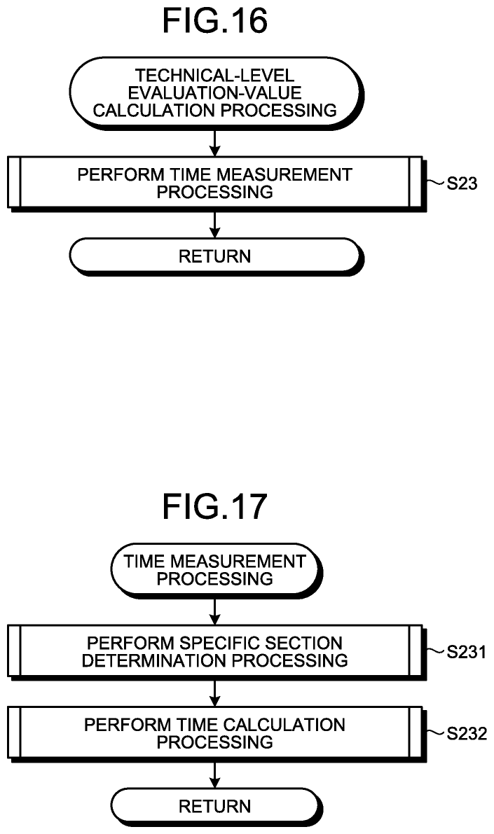

Next, the operation-level evaluation-value calculation processing performed by the image processing apparatus 1f will be described. FIG. 16 is a flowchart illustrating an outline of the operation-level evaluation-value calculation processing performed by the image processing apparatus 1f.

As illustrated in FIG. 16, the time measurement unit 11 performs time measurement processing of measuring the transit time of the specific section (Step S23). After Step S23, the image processing apparatus 1f returns to the above-described main routine in FIG. 2. In the second embodiment, the image recording unit 10 records the transit time of the specific section, which is measured by the time measurement unit 11, in the recording unit 5 or outputs the transit time to the output unit 4, as the technical level of the operator of the endoscope.

Time Measurement Processing

FIG. 17 is a flowchart illustrating an outline of time measurement processing described in Step S23 in FIG. 16.

As illustrated in FIG. 17, the specific section determination unit 12 performs specific section determination processing of determining a specific section for an insertion target into which the endoscope is inserted (Step S231). After Step S231, the image processing apparatus 1f causes the process to proceed to Step S232 described later.

Specific Section Determination Processing

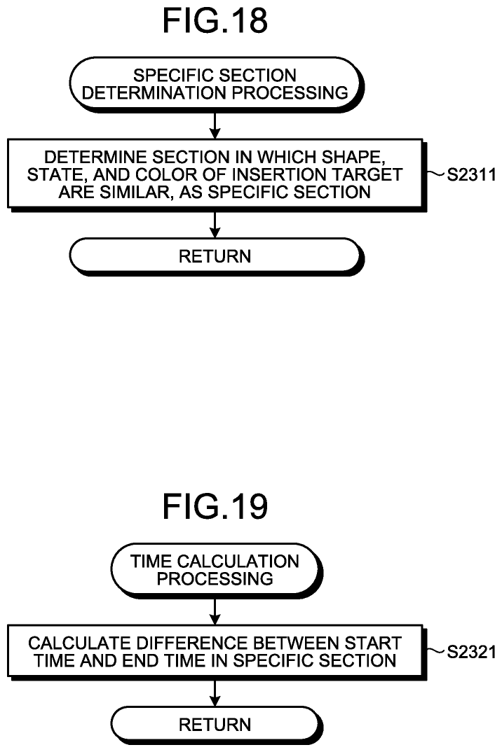

FIG. 18 is a flowchart illustrating an outline of the specific section determination processing described in Step S231 in FIG. 17.

As illustrated in FIG. 18, the insertion target determination unit 121 determines a section in which the shape, the state, and the color of the insertion target are similar, as the specific section (Step S2311). Specifically, in a case where the insertion target is the lower digestive tract, the insertion target determination unit 121 determines a section obtained by appropriately combining any one or more of the rectum, the sigmoid colon, the descending colon, the transverse colon, and the ascending colon, as the specific section, based on the image acquired by the acquisition unit 2. Regarding this, in a case where the insertion target is the upper digestive tract, the insertion target determination unit 121 determines a section obtained by appropriately combining any one or more of the esophagus, the stomach, the duodenum, the jejunum, and the ileum, as the specific section, based on the image acquired by the acquisition unit 2. The combined section may be set in advance by the input unit 3 or may be automatically set using well-known template matching. Even in a case of the industrial endoscope, the insertion target determination unit 121 may determine a section in which the shape, the state, and the color of the insertion target are similar, as the specific section. After Step S2311, the image processing apparatus 1f returns to the above-described subroutine in FIG. 17.

Returning to FIG. 17, descriptions of the processing subsequent to Step S232 continue.

The time calculation unit 13 performs time calculation processing of calculating the transit time based on the specific section determined by the specific section determination unit 12 (Step S232). After Step S232, the image processing apparatus 1f returns to the above-described subroutine in FIG. 16.

Time Calculation Processing

FIG. 19 is a flowchart illustrating an outline of the time calculation processing described in Step S232 in FIG. 17.

As illustrated in FIG. 19, the time calculation unit 13 calculates a difference between the start time and the end time in the specific section (Step S2321). Specifically, the time calculation unit 13 calculates the transit time in the specific section by a difference in imaging time point between an image determined to be a start of the specific section by the specific section determination unit 12 and an image determined to be an end. After Step S2321, the image processing apparatus 1f returns to the above-described subroutine in FIG. 17.

According to the second embodiment of the disclosure, it is possible to exhibit an effect similar to that in the first embodiment described above and to recognize the technical level by the operation of the operator of the endoscope by measuring the transit time in which the endoscope passes by the specific section. Thus, it is possible to recognize the technical level evaluation value of the operator.

### First Modification Example of Second Embodiment

Next, a first modification example of the second embodiment in the disclosure will be described. In the first modification example of the second embodiment, an image processing apparatus has a configuration different from that of the above-described image processing apparatus 1f according to the second embodiment, and specific section determination processing and time calculation processing performed by the image processing apparatus is different. In the following descriptions, the configuration of the image processing apparatus according to the first modification example of the second embodiment will be described. Then, specific section determination processing and time calculation processing performed by the image processing apparatus will be described. The same components as those of the above-described image processing apparatus 1f according to the second embodiment are denoted by the same reference signs, and descriptions thereof will be omitted.

Configuration of Image Processing Apparatus

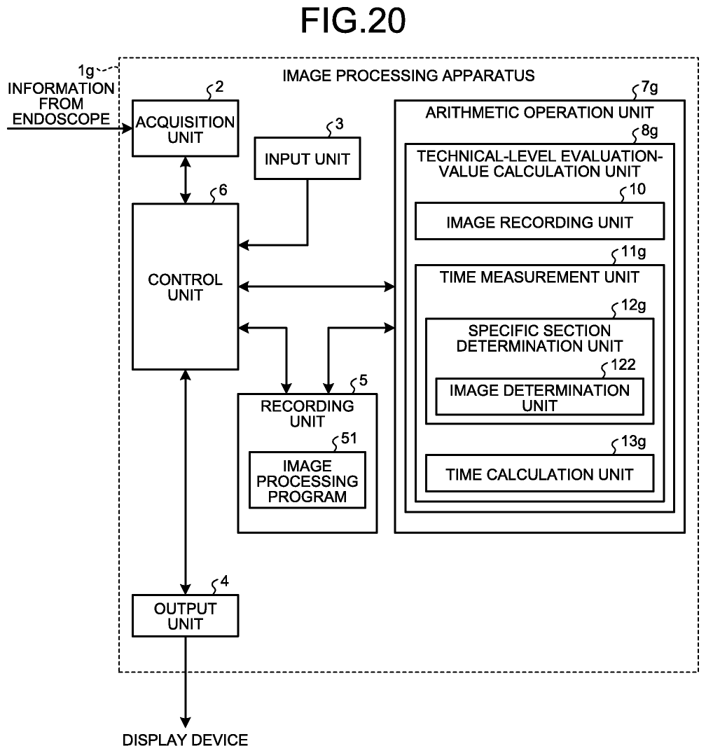

FIG. 20 is a block diagram illustrating the configuration of the image processing apparatus according to the first modification example of the second embodiment of the disclosure. An image processing apparatus 1g illustrated in FIG. 20 includes an arithmetic operation unit 7g instead of the arithmetic operation unit 7f according to the second embodiment described above. The arithmetic operation unit 7g includes a technical-level evaluation-value calculation unit 8g instead of the technical-level evaluation-value calculation unit 8f according to the second embodiment described above. The technical-level evaluation-value calculation unit 8g includes a time measurement unit 11g instead of the time measurement unit 11 in the second embodiment described above. The time measurement unit 11g includes a specific section determination unit 12g and a time calculation unit 13g instead of the specific section determination unit 12 and the time calculation unit 13 according to the second embodiment described above. The specific section determination unit 12g includes an image determination unit 122 that determines an image of the specific section based on preset criteria.

Specific Section Determination Processing

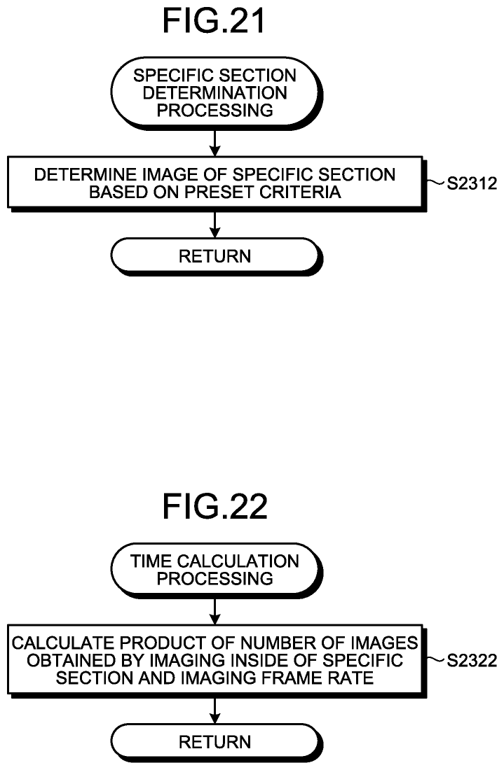

Next, specific section determination processing performed by the image processing apparatus 1f will be described. FIG. 21 is a flowchart illustrating an outline of the specific section determination processing performed by the image processing apparatus 1g.

As illustrated in FIG. 21, the image determination unit 122 determines the image of the specific section based on preset criteria (Step S2312). Here, in a case where the insertion target is the lower digestive tract, the specific section means a section obtained by appropriately combining any one or more of the rectum, the sigmoid colon, the descending colon, the transverse colon, and the ascending colon. In a case where the insertion target is the upper digestive tract, the insertion target determination unit 121 determines a section obtained by appropriately combining any one or more of the esophagus, the stomach, the duodenum, the jejunum, and the ileum, based on the image acquired by the acquisition unit 2. The image determination unit 122 determines the image of the specific section based on criteria indicating features of each organ. After Step S2312, the image processing apparatus 1g returns to the above-described subroutine in FIG. 17.

Time Calculation Processing

Next, the time calculation processing performed by the image processing apparatus 1g will be described. FIG. 22 is a flowchart illustrating an outline of the time calculation processing performed by the image processing apparatus 1g.

As illustrated in FIG. 22, the time calculation unit 13g calculates a product of the number of images obtained by imaging the inside of the specific section and an imaging frame rate (fps) (Step S2322). Specifically, the time calculation unit 13g calculates the transit time of the specific section by the product of the number of images in the specific section determined by the specific section determination unit 12g and the imaging frame rate of the endoscope when the plurality of images are captured. After Step S2322, the image processing apparatus 1g returns to the above-described subroutine in FIG. 17.

According to the first modification example of the second embodiment of the disclosure, it is possible to exhibit an effect similar to that in the first embodiment described above and to recognize the technical level by the operation of the operator of the endoscope by measuring the transit time in which the endoscope passes by the specific section. Thus, it is possible to recognize the technical level evaluation value of the operator.

### Third Embodiment

Next, a third embodiment in the disclosure will be described. In the third embodiment, an image processing apparatus has a configuration different from that of the above-described image processing apparatus 1f according to the second embodiment, and the time measurement processing performed by the image processing apparatus is different. Specifically, in the third embodiment, in the above-described time measurement processing, removal of the endoscope from the insertion target is determined. In the following descriptions, the configuration of the image processing apparatus according to the third embodiment will be described. Then, the time measurement processing performed by the image processing apparatus according to the third embodiment will be described. The same components as those of the above-described image processing apparatus 1f according to the second embodiment are denoted by the same reference signs, and descriptions thereof will be omitted.

Configuration of Image Processing Apparatus

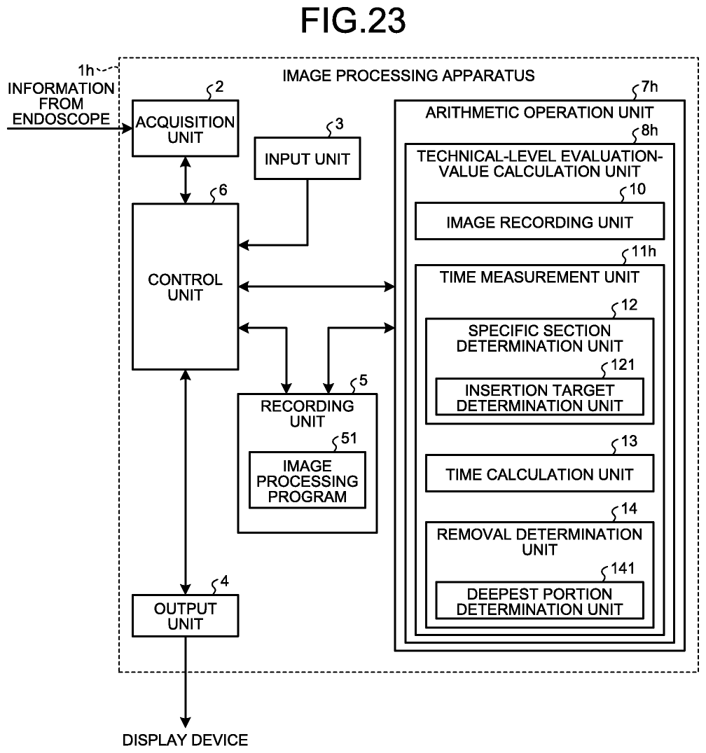

FIG. 23 is a block diagram illustrating a configuration of an image processing apparatus according to the third embodiment of the disclosure. An image processing apparatus 1h illustrated in FIG. 23 includes an arithmetic operation unit 7h instead of the arithmetic operation unit 7f according to the second embodiment described above. The arithmetic operation unit 7h includes a technical-level evaluation-value calculation unit 8h instead of the technical-level evaluation-value calculation unit 8f according to the second embodiment described above. The technical-level evaluation-value calculation unit 8h includes a time measurement unit 11h instead of the time measurement unit 11 according to the second embodiment described above. The time measurement unit 11h further includes a removal determination unit 14 in addition to the configuration of the above-described time measurement unit 11 in the second embodiment.

The removal determination unit 14 determines whether or not the endoscope is removed. The removal determination unit 14 includes a deepest portion determination unit 141 that determines to be a deepest portion as a target.

Time Measurement Processing

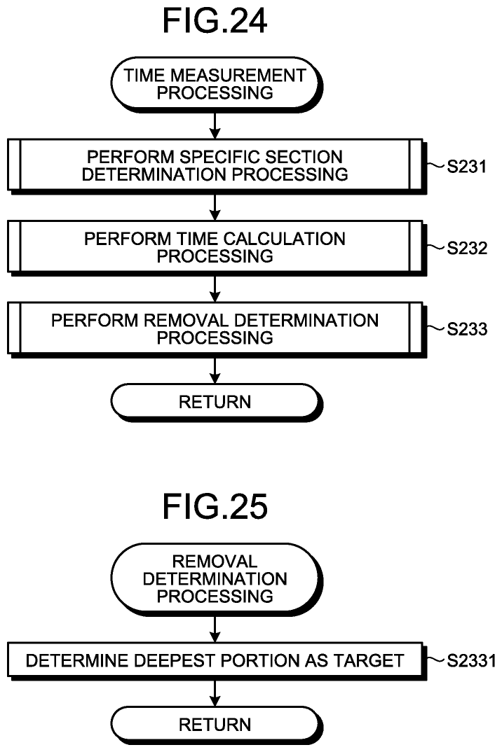

Next, the time measurement processing performed by the image processing apparatus 1g will be described. FIG. 24 is a flowchart illustrating an outline of the time calculation processing performed by the image processing apparatus 1h.

As illustrated in FIG. 24, in the time measurement processing performed by the image processing apparatus 1h, the process of Step S233 is performed in addition to the above-described processes of Step S231 and Step S232 in FIG. 17. The process of Step S233 will be described below.

In Step S233, the removal determination unit 14 performs removal determination processing of determining whether or not the endoscope is removed. After Step S233, the image processing apparatus 1h returns to the above-described subroutine in FIG. 16.

Removal Determination Processing

FIG. 25 is a flowchart illustrating an outline of removal determination processing described in Step S233 in FIG. 24.

As illustrated in FIG. 25, the deepest portion determination unit 141 determines that an image acquired by the acquisition unit 2 shows a deepest portion set as a target (Step S2331). Here, the deepest portion is in the lumen and refers to any of the duodenum, the pylorus, the cardia, the ileocecum, the Bauhin valve, the vermiform appendix, and the rectum. The deepest portion determination unit 141 compares the image acquired by the acquisition unit 2 to criteria which has been created in advance and allows determination to be the deepest portion as the target, and determines whether or not the image shows the deepest portion. For example, the deepest portion determination unit 141 compares the image acquired by the acquisition unit 2 to an identifier created by machine learning and determines whether or not there is the deepest portion. In a case where the predetermined number of images are acquired in advance by the acquisition unit 2, the deepest portion determination unit 141 may determine whether or not there is a deepest portion, by block matching. After Step S2331, the image processing apparatus 1h returns to the above-described subroutine in FIG. 24.

According to the third embodiment of the disclosure, it is possible to exhibit an effect similar to that in the second embodiment described above. In addition, it is possible to collect information indicating whether or not the endoscope can reach the deepest portion by the operation of the operator, and thus to recognize the technical level evaluation value of the operator.

### First Modification Example of Third Embodiment

Next, a first modification example of the third embodiment in the disclosure will be described. In the first modification example in the third embodiment, an image processing apparatus has a configuration different from that of the above-described image processing apparatus 1h according to the third embodiment, and the removal determination processing performed by the image processing apparatus is different. In the following descriptions, the configuration of the image processing apparatus according to the first modification example of the third embodiment will be described. Then, removal determination processing performed by the image processing apparatus according to the first modification example of the third embodiment will be described. The same components as those of the above-described image processing apparatus 1h according to the third embodiment are denoted by the same reference signs, and descriptions thereof will be omitted.

Configuration of Image Processing Apparatus

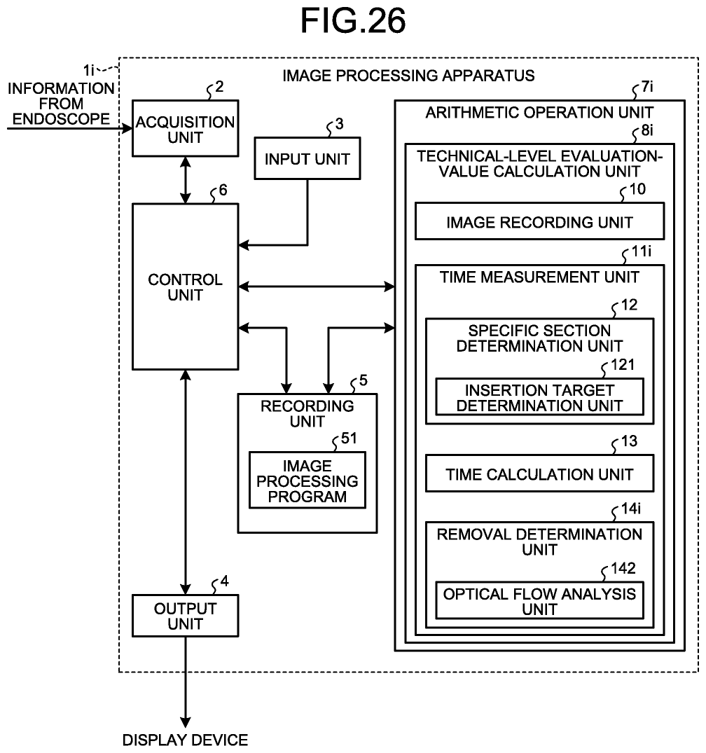

FIG. 26 is a block diagram illustrating the configuration of the image processing apparatus according to the first modification example of the third embodiment of the disclosure. An image processing apparatus 1i illustrated in FIG. 26 includes an arithmetic operation unit 7i instead of the arithmetic operation unit 7h according to the third embodiment described above. The arithmetic operation unit 7i includes a technical-level evaluation-value calculation unit 8i instead of the technical-level evaluation-value calculation unit 8h according to the third embodiment described above. The technical-level evaluation-value calculation unit 8i includes a time measurement unit 11i instead of the time measurement unit 11h according to the third embodiment described above. The time measurement unit 11i includes a removal determination unit 14i instead of the above-described removal determination unit 14 according to the third embodiment.

The removal determination unit 14i determines whether or not the endoscope is removed. The removal determination unit 14i includes an optical flow analysis unit 142 that analyzes an optical flow in the specific section.

Removal Determination Processing

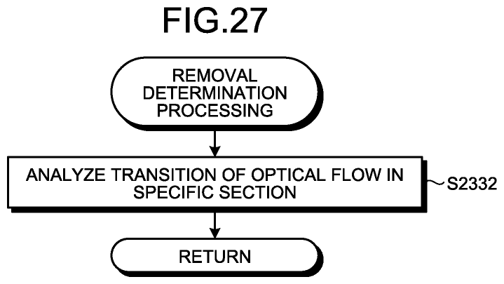

Next, removal determination processing performed by the image processing apparatus 1i will be described. FIG. 27 is a flowchart illustrating an outline of the removal determination processing performed by the image processing apparatus 1i.

As illustrated in FIG. 27, the optical flow analysis unit 142 analyzes a transition of the optical flow in the specific section (Step S2332). Specifically, the optical flow analysis unit 142 calculates an optical flow based on an image group acquired by the acquisition unit 2, analyzes the optical flow in a predetermined time or with a predetermined number of pieces, and analyzes whether or not an optical flow in a direction of removing the endoscope is dominant. After Step S2332, the image processing apparatus 1i returns to the above-described subroutine in FIG. 24.

According to the first modification example of the third embodiment of the disclosure, it is possible to exhibit an effect similar to that in the second embodiment described above. In addition, it is possible to collect information indicating whether or not the endoscope can reach the deepest portion by the operation of the operator, and thus to recognize the technical level evaluation value of the operator.

### Second Modification Example of Third Embodiment

Next, a second modification example of the third embodiment in the disclosure will be described. In the second modification example in the third embodiment, an image processing apparatus has a configuration different from that of the above-described image processing apparatus 1h according to the third embodiment, and removal determination processing performed by the image processing apparatus is different. In the following descriptions, the configuration of the image processing apparatus according to the second modification example of the third embodiment will be described. Then, removal determination processing performed by the image processing apparatus according to the second modification example of the third embodiment will be described. The same components as those of the above-described image processing apparatus 1h according to the third embodiment are denoted by the same reference signs, and descriptions thereof will be omitted.

Configuration of Image Processing Apparatus

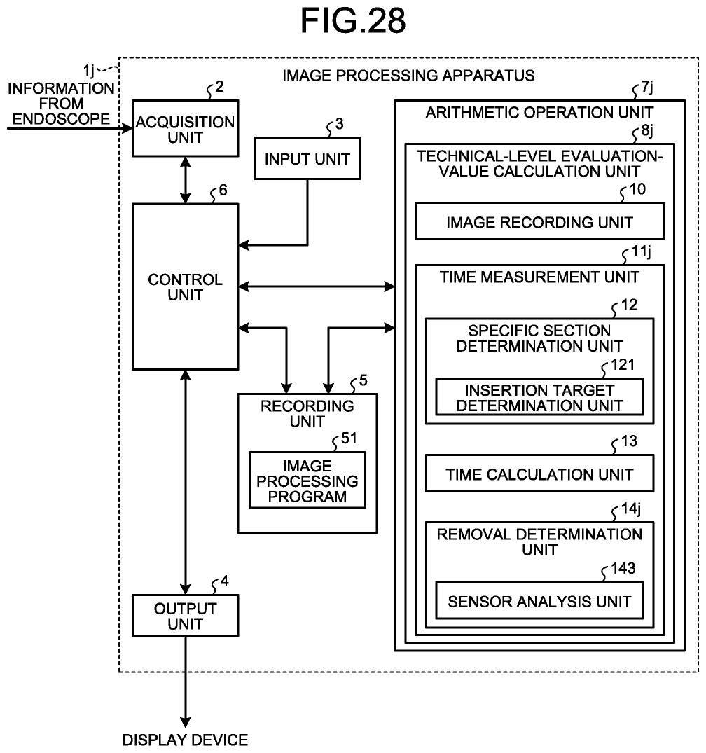

FIG. 28 is a block diagram illustrating the configuration of the image processing apparatus according to the second modification example of the third embodiment of the disclosure. An image processing apparatus 1j illustrated in FIG. 28 includes an arithmetic operation unit 7j instead of the arithmetic operation unit 7h according to the third embodiment described above. The arithmetic operation unit 7j includes a technical-level evaluation-value calculation unit 8j instead of the technical-level evaluation-value calculation unit 8h according to the third embodiment described above. The technical-level evaluation-value calculation unit 8j includes a time measurement unit 11j instead of the time measurement unit 11h according to the third embodiment described above. The time measurement unit 11j includes a removal determination unit 14j instead of the above-described removal determination unit 14 according to the third embodiment.

The removal determination unit 14j determines whether or not the endoscope is removed. The removal determination unit 14j includes a sensor analysis unit 143 that analyzes a transition of the sensor in the specific section.

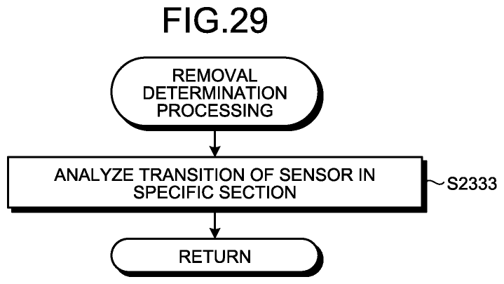

Removal Determination Processing Next, removal determination processing performed by the image processing apparatus 1j will be described. FIG. 29 is a flowchart illustrating an outline of the removal determination processing performed by the image processing apparatus 1j.

As illustrated in FIG. 29, the sensor analysis unit 143 analyzes a transition of the sensor in the specific section (Step S2333). Specifically, the sensor analysis unit 143 calculates a progress direction of the endoscope based on information detected by a sensor included in an image acquired by the acquisition unit 2 and on information which is directly detected by the sensor. The sensor analysis unit compares a distance at which the endoscope progresses in a predetermined time or with a predetermined number of pieces, and a distance at which the endoscope retreats to each other. The sensor analysis unit determines whether or not the retreated distance is dominant. After Step S2333, the image processing apparatus 1j returns to the above-described subroutine in FIG. 24.

According to the second modification example of the third embodiment of the disclosure, it is possible to exhibit an effect similar to that in the second embodiment described above. In addition, it is possible to collect information indicating whether or not the endoscope can reach the deepest portion by the operation of the operator, and thus to recognize the technical level evaluation value of the operator.

### Fourth Embodiment

Next, a fourth embodiment in the disclosure will be described. In the fourth embodiment, an image processing apparatus has a configuration different from that of the above-described image processing apparatus 1h according to the third embodiment, and the time measurement processing performed by the image processing apparatus is different. Specifically, in the fourth embodiment, a handling time of an interested region is excluded from the transit time in the specific section in the above-described time measurement processing in the third embodiment. In the following descriptions, the configuration of the image processing apparatus according to the fourth embodiment will be described. Then, the time measurement processing performed by the image processing apparatus according to the fourth embodiment will be described. The same components as those of the above-described image processing apparatus 1h according to the third embodiment are denoted by the same reference signs, and descriptions thereof will be omitted.

Configuration of Image Processing Apparatus

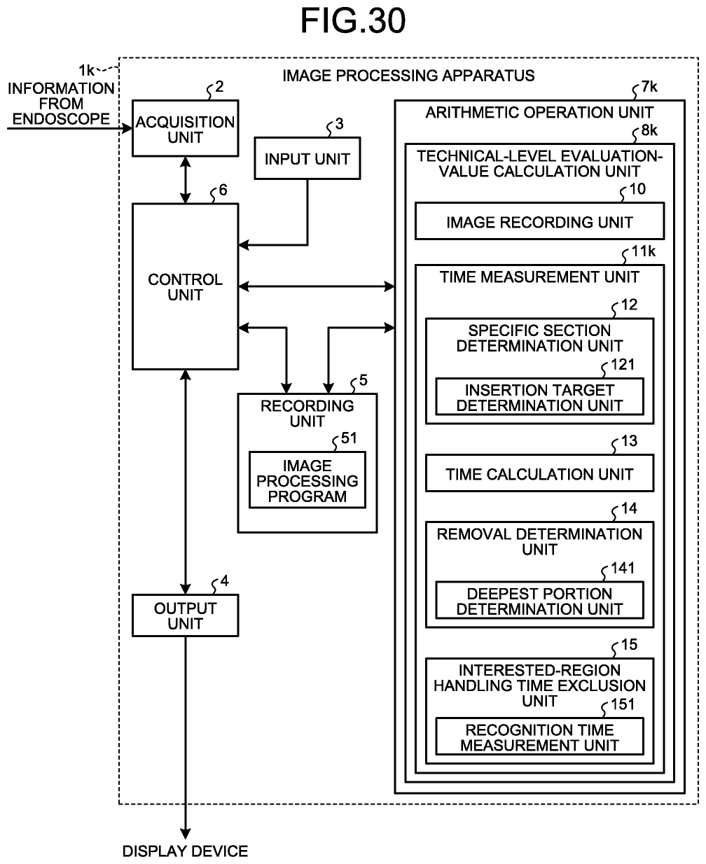

FIG. 30 is a block diagram illustrating a configuration of an image processing apparatus according to the fourth embodiment of the disclosure. An image processing apparatus 1k illustrated in FIG. 30 includes an arithmetic operation unit 7k instead of the arithmetic operation unit 7h according to the third embodiment described above. The arithmetic operation unit 7k includes a technical-level evaluation-value calculation unit 8k instead of the technical-level evaluation-value calculation unit 8h according to the third embodiment described above. The technical-level evaluation-value calculation unit 8k includes a time measurement unit 11k instead of the time measurement unit 11h according to the third embodiment described above. The time measurement unit 11k further includes an interested-region handling time exclusion unit 15 in addition to the configuration of the above-described time measurement unit 11h in the third embodiment.

In a case where the removal determination unit 14 determines that the endoscope is removed, the interested-region handling time exclusion unit 15 excludes the handling time of an interested region from the transit time in the specific section. The interested-region handling time exclusion unit 15 includes a recognition time measurement unit 151 that measures a time to determine whether or not a lesion candidate is to be differentiated.

Time Measurement Processing

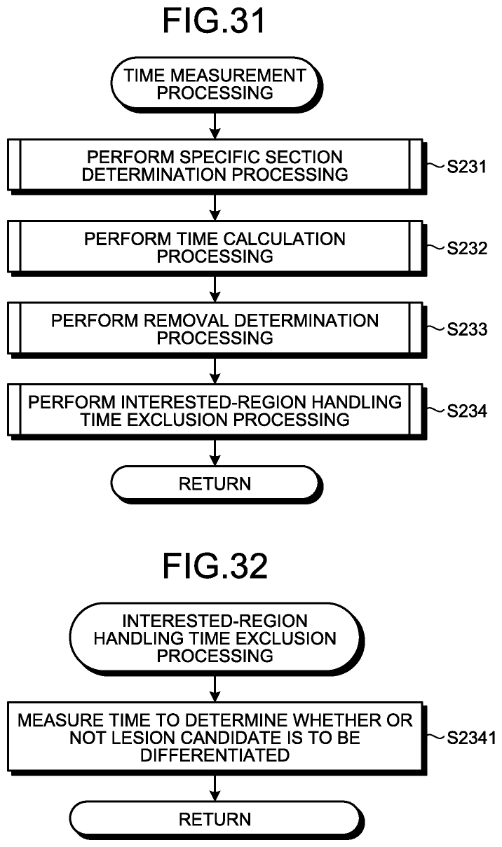

Next, the time measurement processing performed by the image processing apparatus 1k will be described. FIG. 31 is a flowchart illustrating an outline of the time measurement processing performed by the image processing apparatus 1k.

As illustrated in FIG. 31, in the time measurement processing performed by the image processing apparatus 1k, the process of Step S234 is performed in addition to the above-described processes of Step S231 to Step S233 in FIG. 24. The process of Step S234 will be described below.

In Step S234, in a case where the removal determination unit 14 determines that the endoscope is removed, the interested-region handling time exclusion unit 15 performs interested-region handling time exclusion processing of excluding the handling time of the interested region from the transit time in the specific section. After Step S234, the image processing apparatus 1k returns to the above-described subroutine in FIG. 16.

Interested-Region Handling Time Exclusion Processing

FIG. 32 is a flowchart illustrating an outline of the interested-region handling time exclusion processing described in Step S234 in FIG. 31.

As illustrated in FIG. 32, the recognition time measurement unit 151 measures a time to determine whether or not a lesion candidate is to be differentiated (Step S2341). Specifically, if the specific section is in the lumen, the recognition time measurement unit 151 measures a time for a user to determine whether or not a protrusion of a mucosa or a polyp is a lesion (lesion candidate) having a need to be differentiated. In this case, regardless of removal of the endoscope, the user moves the distal end portion of the endoscope in a deep direction in the lumen or bends the distal end portion in a direction in which the user wants to check a portion, such that the user determines whether or not the protrusion of the mucosa or the polyp is a lesion (lesion candidate) having a need to be differentiated. Therefore, in a case where the removal determination unit 14 determines that the endoscope is removed, the recognition time measurement unit 151 determines whether or not the distal end portion of the endoscope moves in the deep direction in the lumen or whether or not the distal end portion of the endoscope is bent, based on an image acquired by the acquisition unit 2. When it is determined that the distal end portion of the endoscope moves in the deep direction in the lumen or is bent, the recognition time measurement unit measures a time in which the distal end portion moves (product of the number of imaged pieces and the imaging frame rate) or a time in which the distal end portion is bent, and excludes the measurement time from the transit time in the specific section. The recognition time measurement unit measures the time by a difference between a start time and an end time of an image determined to move in the deep direction or to be bent, and excludes the measured time from the transit time in the specific section. After Step S2341, the image processing apparatus 1k returns to the above-described subroutine in FIG. 31.

According to the fourth embodiment of the disclosure described above, it is possible to exhibit the above-described effect in the second embodiment. Regarding the technical level by the operation of the operator of the endoscope, since the time corresponding to the interested region is excluded from the transit time in which the endoscope passes in the specific section, it is possible to accurately measure the transit time in which the endoscope passes in the specific section and to recognize the technical level evaluation value of the operator with higher accuracy.

### First Modification Example of Fourth Embodiment

Next, a first modification example of the fourth embodiment in the disclosure will be described. In the first modification example in the fourth embodiment, an image processing apparatus has a configuration different from that of the above-described image processing apparatus 1k according to the fourth embodiment, and interested-region handling time exclusion processing performed by the image processing apparatus is different. In the following descriptions, the configuration of the image processing apparatus according to the first modification example of the fourth embodiment will be described. Then, interested-region handling time exclusion processing performed by the image processing apparatus according to the first modification example of the fourth embodiment will be described. The same components as those of the above-described image processing apparatus 1k according to the fourth embodiment are denoted by the same reference signs, and descriptions thereof will be omitted.

Configuration of Image Processing Apparatus

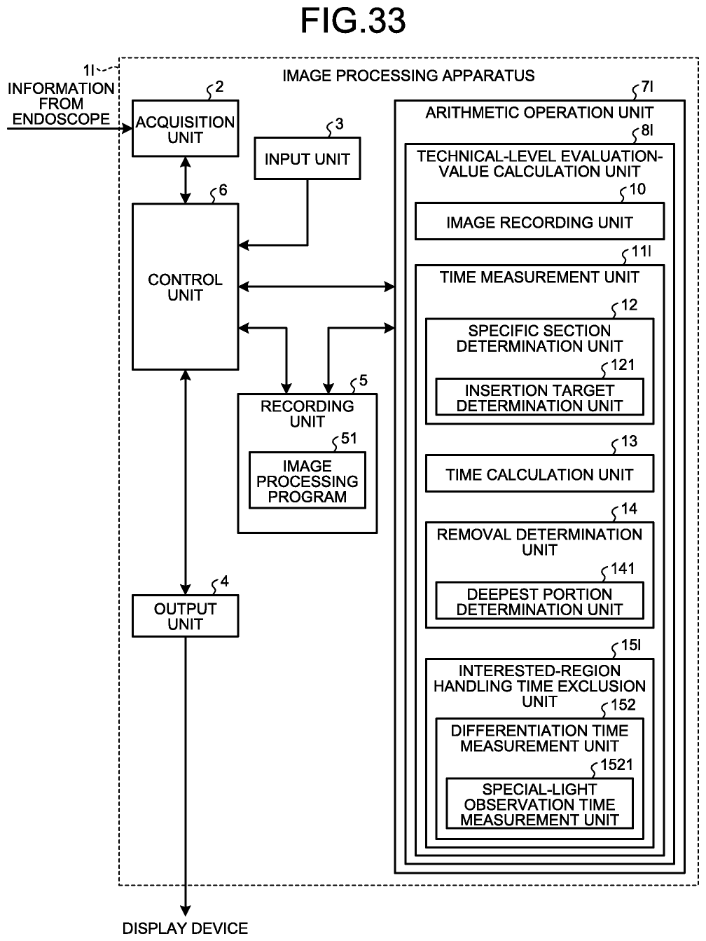

FIG. 33 is a block diagram illustrating the configuration of the image processing apparatus according to the first modification example of the fourth embodiment of the disclosure. An image processing apparatus 1l illustrated in FIG. 33 includes an arithmetic operation unit 7l instead of the arithmetic operation unit 7k according to the fourth embodiment described above. The arithmetic operation unit 7l includes a technical-level evaluation-value calculation unit 8l instead of the technical-level evaluation-value calculation unit 8k according to the fourth embodiment described above. The technical-level evaluation-value calculation unit 8l includes a time measurement unit 11l instead of the time measurement unit 11k according to the fourth embodiment described above. The time measurement unit 11l includes an interested-region handling time exclusion unit 15l instead of the above-described interested-region handling time exclusion unit 15 according to the fourth embodiment. The interested-region handling time exclusion unit 15l includes a differentiation time measurement unit 152 instead of the above-described recognition time measurement unit 151 according to the fourth embodiment.

The differentiation time measurement unit 152 measures a time to differentiate a lesion candidate and to determine a treatment method. The differentiation time measurement unit 152 includes a special-light observation time measurement unit 1521 that measures a time in which a lesion is observed with special light.

Interested-Region Handling Time Exclusion Processing

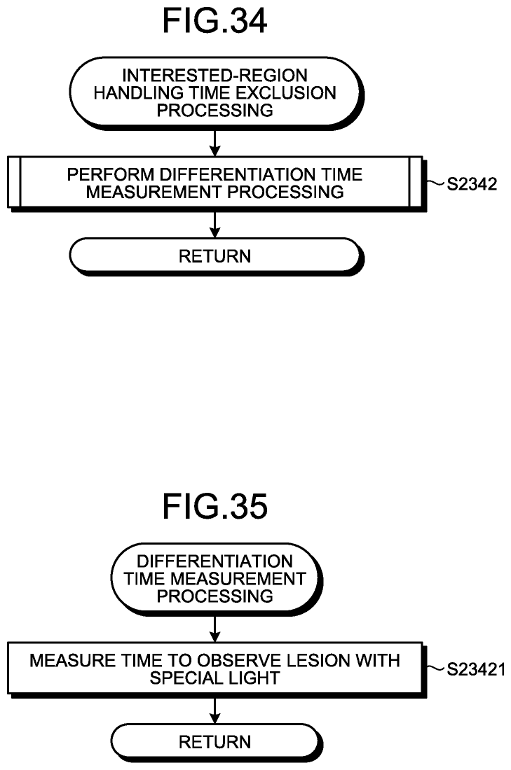

Next, interested-region handling time exclusion processing performed by the image processing apparatus 1l will be described. FIG. 34 is a flowchart illustrating an outline of the interested-region handling time exclusion processing performed by the image processing apparatus 1l.

As illustrated in FIG. 34, the differentiation time measurement unit 152 performs differentiation time measurement processing of measuring a time to differentiate a lesion candidate and to determine a treatment method (Step S2342). Specifically, in any of a case where a lesion region is provided in an image acquired by the acquisition unit 2, and the distal end portion of the endoscope moves by a distance shorter than a predetermined distance, and a case where the number of operations received by the endoscope is less than a predetermined number, the differentiation time measurement unit 152 performs differentiation time measurement processing. After Step S2342, the image processing apparatus 1l returns to the above-described subroutine in FIG. 31.

Differentiation Time Measurement Processing

FIG. 35 is a flowchart illustrating an outline of differentiation time measurement processing described in Step S2342 in FIG. 34.

As illustrated in FIG. 35, the special-light observation time measurement unit 1521 measures a time to observe a lesion with special light (Step S23421). Specifically, the special-light observation time measurement unit 1521 determines whether or not special light is observed, based on a hue change of an image acquired by the acquisition unit 2 or information from a light source device, which is included in information from the endoscope, which has been acquired by the acquisition unit 2. When it is determined that special light observation is performed, the special-light observation time measurement unit measures the time in which the special light observation is performed. In this case, the special-light observation time measurement unit 1521 measures the time by calculating an imaging time included in the above-described image or by calculating a product of the imaging frame rate of the endoscope and the number of images from a start time point at which special light observation starts to an end time point at which the special light observation ends. Alternatively, the special-light observation time measurement unit measures the time by a difference in operation between a start time and an end time. After Step S23421, the image processing apparatus 1l returns to the above-described subroutine in FIG. 34.

According to the first modification example of the fourth embodiment of the disclosure described above, it is possible to exhibit the above-described effect in the second embodiment. Regarding the technical level by the operation of the operator of the endoscope, since the time corresponding to the interested region is excluded from the transit time in which the endoscope passes in the specific section, it is possible to accurately measure the transit time in which the endoscope passes in the specific section and to recognize the technical level evaluation value of the operator with higher accuracy.

### Second Modification Example of Fourth Embodiment

Next, a second modification example of the fourth embodiment in the disclosure will be described. In the second modification example in the fourth embodiment, an image processing apparatus has a configuration different from that of the above-described image processing apparatus 1k according to the fourth embodiment, and differentiation time measurement processing performed by the image processing apparatus is different. In the following descriptions, the configuration of the image processing apparatus according to the second modification example of the fourth embodiment will be described. Then, differentiation time measurement processing performed by the image processing apparatus according to the second modification example of the fourth embodiment will be described. The same components as those of the above-described image processing apparatus 1k according to the fourth embodiment are denoted by the same reference signs, and descriptions thereof will be omitted.

Configuration of Image Processing Apparatus

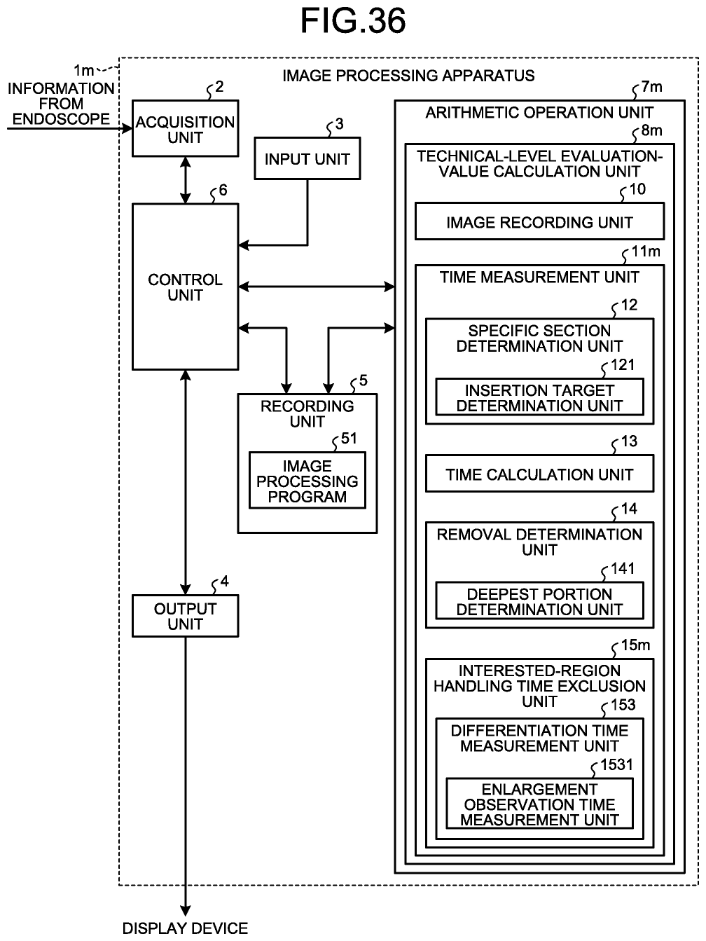

FIG. 36 is a block diagram illustrating the configuration of the image processing apparatus according to the second modification example of the fourth embodiment of the disclosure. An image processing apparatus 1m illustrated in FIG. 36 includes an arithmetic operation unit 7m instead of the arithmetic operation unit 7k according to the fourth embodiment described above. The arithmetic operation unit 7m includes a technical-level evaluation-value calculation unit 8m instead of the technical-level evaluation-value calculation unit 8k according to the fourth embodiment described above. The technical-level evaluation-value calculation unit 8m includes a time measurement unit 11m instead of the time measurement unit 11k according to the fourth embodiment described above. The time measurement unit 11m includes an interested-region handling time exclusion unit 15m instead of the above-described interested-region handling time exclusion unit 15 according to the fourth embodiment. The interested-region handling time exclusion unit 15m includes a differentiation time measurement unit 153 instead of the above-described recognition time measurement unit 151 according to the fourth embodiment. The differentiation time measurement unit 153 includes an enlargement observation time measurement unit 1531 that measures a time to enlarge and observe a lesion.

Differentiation Time Measurement Processing

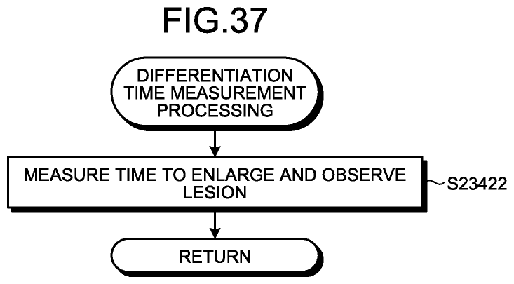

Next, differentiation time measurement processing performed by the image processing apparatus 1m will be described. FIG. 37 is a flowchart illustrating an outline of the differentiation time measurement processing performed by the image processing apparatus 1m.

As illustrated in FIG. 37, the enlargement observation time measurement unit 1531 measures a time to enlarge and observe a lesion (Step S23422). Specifically, the enlargement observation time measurement unit 1531 measures a time to enlarge and observe a lesion, based on operation information included in an image acquired by the acquisition unit 2 or information from the endoscope, which is acquired by the acquisition unit 2. For example, regardless of the same subject (main subject) among temporal images acquired by the acquisition unit 2, the enlargement observation time measurement unit 1531 determines whether or not a proportion of an area for a subject in the image increases to be more than a predetermined value. When it is determined that the proportion of the area for the subject increases to be more than the predetermined value, the enlargement observation time measurement unit measures a time to enlarge and observe the lesion. In this case, the enlargement observation time measurement unit 1531 measures the time by calculating an imaging time included in the above-described image or by calculating a product of the imaging frame rate of the endoscope and the number of images from a start time point at which the lesion is enlarged, and observation starts to an end time point at which the observation ends. Alternatively, the enlargement observation time measurement unit measures the time by the difference. After Step S23422, the image processing apparatus 1m returns to the above-described subroutine in FIG. 34.

According to the second modification example of the fourth embodiment of the disclosure described above, it is possible to exhibit the above-described effect in the second embodiment. Regarding the technical level by the operation of the operator of the endoscope, since the time corresponding to the interested region is excluded from the transit time in which the endoscope passes in the specific section, it is possible to accurately measure the transit time in which the endoscope passes in the specific section and to recognize the technical level evaluation value of the operator with higher accuracy.

### Third Modification Example of Fourth Embodiment

Next, a third modification example of the fourth embodiment in the disclosure will be described. In the third modification example in the fourth embodiment, an image processing apparatus has a configuration different from that of the above-described image processing apparatus 1k according to the fourth embodiment, and differentiation time measurement processing performed by the image processing apparatus is different. In the following descriptions, the configuration of the image processing apparatus according to the third modification example of the fourth embodiment will be described. Then, differentiation time measurement processing performed by the image processing apparatus according to the third modification example of the fourth embodiment will be described. The same components as those of the above-described image processing apparatus 1k according to the fourth embodiment are denoted by the same reference signs, and descriptions thereof will be omitted.

Configuration of Image Processing Apparatus

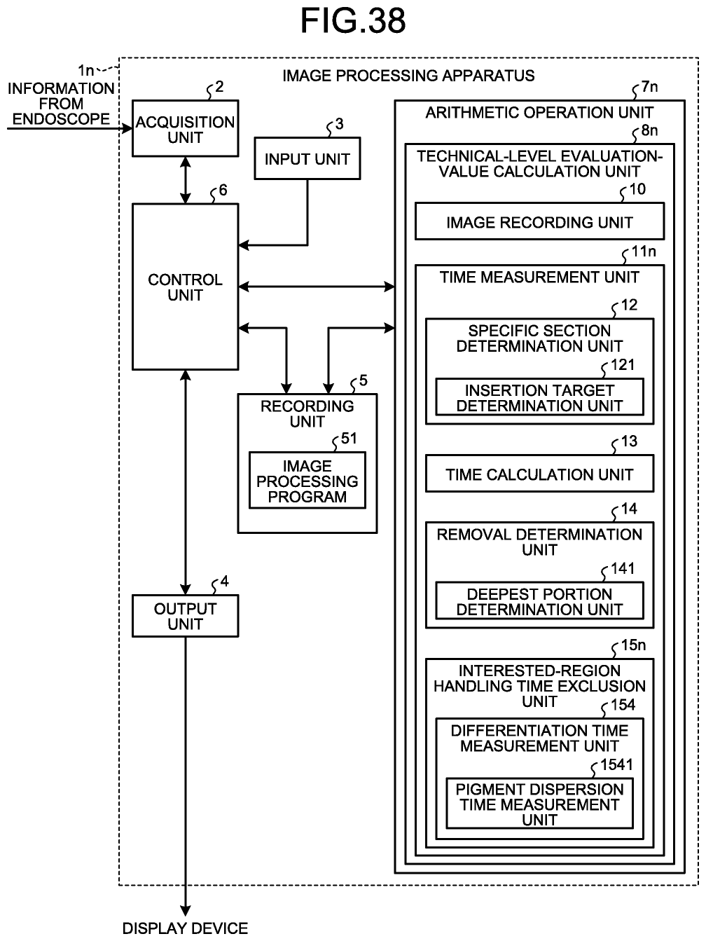

FIG. 38 is a block diagram illustrating the configuration of the image processing apparatus according to the third modification example of the fourth embodiment of the disclosure. An image processing apparatus 1n illustrated in FIG. 38 includes an arithmetic operation unit 7n instead of the arithmetic operation unit 7k according to the fourth embodiment described above. The arithmetic operation unit 7n includes a technical-level evaluation-value calculation unit 8n instead of the technical-level evaluation-value calculation unit 8k according to the fourth embodiment described above. The technical-level evaluation-value calculation unit 8n includes a time measurement unit 11n instead of the time measurement unit 11k according to the fourth embodiment described above. The time measurement unit 11n includes an interested-region handling time exclusion unit 15n instead of the above-described interested-region handling time exclusion unit 15 according to the fourth embodiment. The interested-region handling time exclusion unit 15n includes a differentiation time measurement unit 154 instead of the above-described recognition time measurement unit 151 according to the fourth embodiment. The differentiation time measurement unit 154 includes a pigment dispersion time measurement unit 1541 that measures a time in which pigments are dispersed in the lesion, and the lesion is observed.

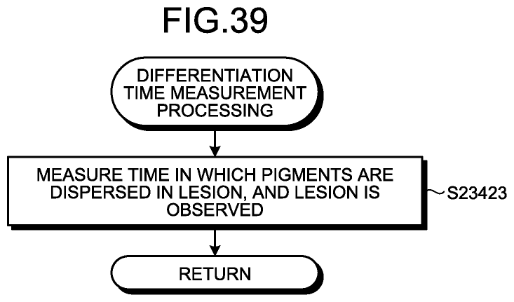

Differentiation Time Measurement Processing Next, differentiation time measurement processing performed by the image processing apparatus 1n will be described. FIG. 39 is a flowchart illustrating an outline of the differentiation time measurement processing performed by the image processing apparatus 1n.

As illustrated in FIG. 39, the pigment dispersion time measurement unit 1541 measures a time in which pigments are dispersed in the lesion, and the lesion is observed (Step S23423). Specifically, the pigment dispersion time measurement unit 1541 determines whether or not the pigment is dispersed in the lesion, and the lesion is observed, based on the hue change or an intensity change at an edge in an image acquired by the acquisition unit 2. When it is determined that the pigment is dispersed in the lesion, and the lesion is observed, the pigment dispersion time measurement unit measures a time in which the pigment is dispersed in the lesion, and the lesion is observed. In this case, the pigment dispersion time measurement unit 1541 measures a time from a start time point at which the hue change or the intensity change at the edge is detected to an end time point at which it is not possible to detect the hue change or the intensity change at the edge, in images which have been sequentially acquired by the acquisition unit 2. At this time, the pigment dispersion time measurement unit 1541 measures the time by calculating an imaging time included in the above-described image or by calculating a product of the imaging frame rate of the endoscope and the number of images from the start time point at which the hue change or the intensity change at the edge is detected to the end time point at which it is not possible to detect the hue change or the intensity change at the edge. After Step S23423, the image processing apparatus 1n returns to the above-described subroutine in FIG. 34.

According to the third modification example of the fourth embodiment of the disclosure described above, it is possible to exhibit the above-described effect in the second embodiment. Regarding the technical level by the operation of the operator of the endoscope, since the time corresponding to the interested region is excluded from the transit time in which the endoscope passes in the specific section, it is possible to accurately measure the transit time in which the endoscope passes in the specific section and to recognize the technical level evaluation value of the operator with higher accuracy.

### Fourth Modification Example of Fourth Embodiment

Next, a fourth modification example of the fourth embodiment in the disclosure will be described. In the fourth modification example in the fourth embodiment, an image processing apparatus has a configuration different from that of the above-described image processing apparatus 1k according to the fourth embodiment, and interested-region handling time exclusion processing performed by the image processing apparatus is different. In the following descriptions, the configuration of the image processing apparatus according to the fourth modification example of the fourth embodiment will be described. Then, interested-region handling time exclusion processing performed by the image processing apparatus according to the fourth modification example of the fourth embodiment will be described. The same components as those of the above-described image processing apparatus 1k according to the fourth embodiment are denoted by the same reference signs, and descriptions thereof will be omitted.

Configuration of Image Processing Apparatus

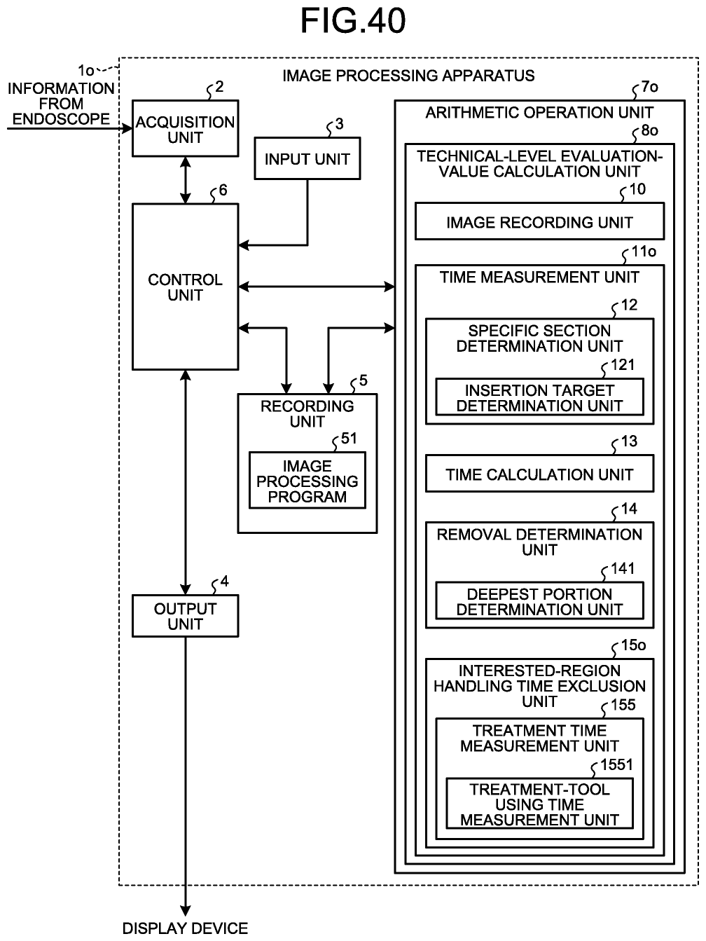

FIG. 40 is a block diagram illustrating the configuration of the image processing apparatus according to the fourth modification example of the fourth embodiment of the disclosure. An image processing apparatus 10 illustrated in FIG. 40 includes an arithmetic operation unit 7o instead of the arithmetic operation unit 7k according to the fourth embodiment described above. The arithmetic operation unit 7o includes a technical-level evaluation-value calculation unit 8o instead of the technical-level evaluation-value calculation unit 8k according to the fourth embodiment described above. The technical-level evaluation-value calculation unit 8o includes a time measurement unit 11o instead of the time measurement unit 11k according to the fourth embodiment described above. The time measurement unit 11o includes an interested-region handling time exclusion unit 15o instead of the above-described interested-region handling time exclusion unit 15 according to the fourth embodiment. The interested-region handling time exclusion unit 15o includes a treatment time measurement unit 155 that measures a time to treat a lesion, instead of the above-described recognition time measurement unit 151 according to the fourth embodiment. The treatment time measurement unit 155 includes a treatment-tool using time measurement unit 1551 that measures a time to use a treatment tool time.

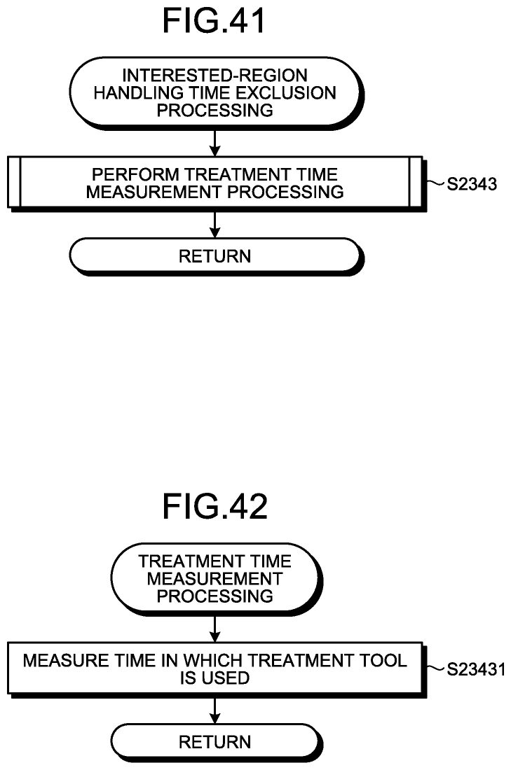

Interested-region Handling Time Exclusion Processing Next, interested-region handling time exclusion processing performed by the image processing apparatus 10 will be described. FIG. 41 is a flowchart illustrating an outline of the interested-region handling time exclusion processing performed by the image processing apparatus 1o.

As illustrated in FIG. 41, the treatment time measurement unit 155 performs treatment time measurement processing of measuring a time to treat a lesion (Step S2343). After Step S2343, the image processing apparatus 10 returns to the above-described subroutine in FIG. 31.

Treatment Time Measurement Processing

FIG. 42 is a flowchart illustrating an outline of treatment time measurement processing described in Step S2343 in FIG. 41.

As illustrated in FIG. 42, the treatment-tool using time measurement unit 1551 compares an image acquired by the acquisition unit 2 to criteria which have been created in advance, and measures a treatment-tool using time (Step S23431). Here, forceps, an electric knife, an energy device, a puncture needle, and the like are provided as the treatment tool. The treatment-tool using time measurement unit 1551 measures a time from a start time point at which a treatment tool is detected to an end time point at which it is not possible to detect the treatment tool, in images which have sequentially acquired by the acquisition unit 2, as the treatment-tool using time. In this case, the treatment-tool using time measurement unit 1551 may measure the treatment-tool using time by calculating an imaging time included in the above-described image or by calculating a product of the imaging frame rate of the endoscope and the number of images from the start time point at which the treatment tool is detected to the end time point at which it is not possible to detect the treatment tool. After Step S23431, the image processing apparatus 10 returns to the above-described subroutine in FIG. 41.

According to the fourth modification example of the fourth embodiment of the disclosure described above, it is possible to exhibit the above-described effect in the second embodiment. Regarding the technical level by the operation of the operator of the endoscope, since the time corresponding to the interested region is excluded from the transit time in which the endoscope passes in the specific section, it is possible to accurately measure the transit time in which the endoscope passes in the specific section and to recognize the technical level evaluation value of the operator with higher accuracy.

### OTHER EMBODIMENTS

In the disclosure, an image processing program recorded in a recording apparatus can be realized by being executed on a computer system such as a personal computer or a workstation. Such a computer system may be used by being connected to other computer systems or devices such as servers via a public line such as a local area network (LAN), a wide area network (WAN), or the Internet. In this case, the image processing apparatus according to the first to the fourth embodiments and the modification examples thereof may acquire image data of an image in a lumen via the network, output an image processing result to various output devices such as a viewer or a printer, which are connected via the networks, or store the image processing results in a storage device connected via the network, for example, in a readable recording medium by a reading device which is connected to the network.

In the description of the flowchart in the present specification, the context of processing between steps is clearly shown using expressions such as “first”, “subsequent”, and “follow”, but this is necessary for carrying out the disclosure. The order of processing is not uniquely determined by their expression. That is, the order of the processing in the flowchart described in this specification can be changed in a consistent range.

The disclosure is not limited to the first to the fourth embodiments and the modification examples thereof, and various embodiments can be formed by appropriately combining a plurality of constituent components disclosed in the embodiments and the modification examples. For example, an embodiment may be formed by excluding some constituent components from all constituent components described in the embodiments and the modification examples, or may be formed by appropriately combining constituent components disclosed in the different embodiment and modification examples.

According to the disclosure, an effect that it is possible to collect information regarding a technical level of an operator who operates an endoscope is exhibited.

Additional advantages and modifications will readily occur to those skilled in the art. Therefore, the disclosure in its broader aspects is not limited to the specific details and representative embodiments shown and described herein. Accordingly, various modifications may be made without departing from the spirit or scope of the general inventive concept as defined by the appended claims and their equivalents.

What is claimed is:

1. An image processing apparatus comprising:
a processor including hardware, the processor being configured to
evaluate, based on information including an image which is captured by an endoscope and is sequentially input, a technical level of an operator who operates the endoscope, and
measure a transit time of a specific section.

2. The image processing apparatus according to claim 1, wherein the processor is configured to
determine a specific scene photographed in the image, and
add and record identification information for distinguishment from another image to the image in which the determined specific scene is photographed.

3. The image processing apparatus according to claim 2, wherein the processor is further configured to determine a deepest portion as a target.

4. The image processing apparatus according to claim 2, wherein the processor is configured to determines a preset passage point.

5. The image processing apparatus according to claim 2, wherein the processor is configured to determine a target place of follow-up observation.

6. The image processing apparatus according to claim 2, wherein the processor is configured to determine a target place for treatment.

7. The image processing apparatus according to claim 2, wherein the processor is configured to determine a scene in which a distal end portion of the endoscope is photographed.

8. The image processing apparatus according to claim 2, wherein the processor is configured to determine a target place in which progress fails.

9. The image processing apparatus according to claim 1, wherein the time processor is configured to
determine the specific section in an insertion target of the endoscope, and
calculate the transit time based on the specific section.

10. The image processing apparatus according to claim 9, wherein the specific section is a section having a shape, a state, and a color of which at least one or more is similar to that of the insertion target.

11. The image processing apparatus according to claim 9, wherein the processor is configured to determine an image of the specific section based on a preset criterion.

12. The image processing apparatus according to claim 9, wherein the processor is configured to calculate a difference between a start time and an end time of the specific section as the transit time or calculate a product of the number of images and an imaging frame rate of the endoscope, as the transit time, the images obtained by imaging of the endoscope in the specific section.

13. The image processing apparatus according to claim 9, wherein the processor is configured to determine whether or not the endoscope is removed.

14. The image processing apparatus according to claim 13, wherein the processor is configured to measure each of a differentiation time for differentiating a lesion candidate and a time to determine a treatment method of treating the lesion candidate.

15. The image processing apparatus according to claim 13, wherein the processor is configured to measure a time in which treatment is performed on a subject.

16. The image processing apparatus according to claim 15, wherein the processor is configured to measure a time in which a treatment tool is used.

17. The image processing apparatus according to claim 1, wherein the processor is further configured to output a technical level evaluation value indicating the technical level.

18. An image processing method comprising:
acquiring information including an image which is captured by an endoscope and is sequentially input;
evaluating a technical level of an operator who operates the endoscope based on the information; and
measuring a transit time of a specific section.

19. A non-transitory computer-readable recording medium with an executable program stored thereon, the program causing an image processing apparatus to execute:
acquiring information including an image which is captured by an endoscope and is sequentially input;
evaluating a technical level of an operator who operates the endoscope based on the information; and
measuring a transit time of a specific section.
